(19) United States
(12) Patent Application Publication
(10) Pub. No.: US 2026/0030295 A1
(43) Pub. Date: Jan. 29, 2026

(54) METHODS AND SYSTEMS FOR PROCESSING VIDEO IMAGE METADATA

(71) Applicants: GENETEC INC., Montreal (CA); Genetec Austria GmbH, Wien (AT)

(72) Inventors: Florian Matusek, Vienna (AT); Pierre Racz, Montreal (CA); Georg Zankl, Vienna (AT); Joshua De Vries, Vienna (AT)

(21) Appl. No.: 19/342,333

(22) Filed: Sep. 26, 2025

Related U.S. Application Data
(63) Continuation-in-part of application No. PCT/IB2024/059110, filed on Sep. 19, 2024.
(63) Continuation-in-part of application No. 18/631,513, filed on Apr. 10, 2024.
Application No. PCT/IB2024/059110 is a continuation-in-part of application No. 18/631,513, filed on Apr. 10, 2024.
(60) Provisional application No. 63/540,400, filed on Sep. 26, 2023.
(60) Provisional application No. 63/540,400, filed on Sep. 26, 2023.
(60) Provisional application No. 63/882,980, filed on Sep. 16, 2025.
(60) Provisional application No. 63/883,553, filed on Sep. 17, 2025.

(51) Int. Cl. G06F 16/783; G06F 3/0482

(52) U.S. Cl. CPC G06F 16/7837; G06F 3/0482

(57) ABSTRACT

An example method of operating a computing apparatus, which comprises: obtaining, via a graphical user interface, user input indicative of a query relating to a video image of a scene captured by a camera; accessing an object stream data store comprising a plurality of object-based metadata records, each object-based metadata record of the plurality of object-based metadata records associated with a corresponding object depicted in video images captured by the camera and comprising at least one object stream comprising (i) an object identifier (ID) and (ii) one or more object attributes associated with the corresponding object, the object stream data store comprising aggregated identification information for video images in which the corresponding object was detected; identifying, based on the query, an object of interest from amongst objects depicted in the video images captured by the camera, the object of interest associated with a particular object-based metadata record; obtaining, from the object stream, additional information pertaining to the object of interest; and presenting, via the graphical user interface, at least the additional information.

### CROSS-REFERENCE TO RELATED APPLICATION

This application is a continuation-in-part application of:
U.S. patent application Ser. No. 18/631,513 filed on Apr. 10, 2024; and
PCT Patent Application Serial No. PCT/IB2024/059110 filed on Sep. 19, 2024.

This application also claims priority to U.S. Provisional Patent Application Ser. No. 63/882,980 filed on Sep. 16, 2025 and U.S. Provisional Patent Application Ser. No. 63/883,553 filed on Sep. 17, 2025.

U.S. patent application Ser. No. 18/631,513 claims priority to U.S. Provisional Patent Application Ser. No. 63/540,400 filed on Sep. 26, 2023.

PCT Patent Application Serial No. PCT/IB2024/059110 claims priority to U.S. patent application Ser. No. 18/631,513 filed on Apr. 10, 2024 and U.S. Provisional Patent Application Ser. No. 63/540,400 filed on Sep. 26, 2023.

The entirety of U.S. Provisional Patent Application Ser. No. 63/540,400 filed on Sep. 26, 2023, U.S. patent application Ser. No. 18/631,513 filed on Apr. 10, 2024, PCT Patent Application Serial No. PCT/IB2024/059110 field on Sep. 19, 2024, U.S. Provisional Patent Application Ser. No. 63/882,980 filed on Sep. 16, 2025 and U.S. Provisional Patent Application Ser. No. 63/883,553 filed on Sep. 17, 2025 are hereby incorporated by reference herein.

### FIELD

The present disclosure relates to methods and systems for processing metadata in video images and for managing playback of video images based on user-specified metadata.

### BACKGROUND

Forensic investigations based on video imagery involve searching for the presence of certain objects in a scene, such as a vehicle or person having specific characteristics. To accomplish this, a forensic investigator will typically have access to temporal metadata associated with video image frames of the scene. The temporal metadata may indicate, for each video image frame, what objects were detected to be in that frame, and the characteristics or attributes of such objects. However, if the investigator is interested in knowing when an object having a certain combination of characteristics was present in the scene, they need to consider the temporal metadata for each and every frame in order to account for the possibility that an object of interest might have been detected in the scene during that frame. This renders the investigative process time-consuming and inefficient. A technological solution would be welcomed.

### SUMMARY

An aspect of the present disclosure provides a method of operating a computing apparatus. The method comprises: obtaining, via a graphical user interface, user input indicative of a query relating to a video image of a scene captured by a camera; accessing an object stream data store comprising a plurality of object-based metadata records, each object-based metadata record of the plurality of object-based metadata records associated with a corresponding object depicted in video images captured by the camera and comprising at least one object stream comprising (i) an object identifier (ID) and (ii) one or more object attributes associated with the corresponding object, the object stream data store comprising aggregated identification information for video images in which the corresponding object was detected; identifying, based on the query, an object of interest from amongst objects depicted in the video images captured by the camera, the object of interest associated with a particular object-based metadata record; obtaining, from the object stream, additional information pertaining to the object of interest; and presenting, via the graphical user interface, at least the additional information.

In some embodiments, the user input is indicative of a selection of one of a plurality of objects depicted in the video image. In some embodiments, identifying the object of interest comprises assigning the object of interest as a selected object from amongst the plurality of objects.

In some embodiments, the user input being indicative of the selection of the one of the plurality of objects depicted in the video image comprises the user input being an interaction with a list displayed within the graphical user interface.

In some embodiments, the user input is indicative of a region of interest in the video image.

In some embodiments, the user input is indicative of an object located within the region of interest. In some embodiments, identifying the object of interest based on the query comprises assigning the object of interest as the object located within the region of interest.

In some embodiments, the method further comprises determining that the region of interest indicated by the user input is devoid of any object. In some embodiments, identifying the object of interest based on the query comprises identifying an object present within the region of interest at a different time than a time associated with the query and assigning the object of interest as the object present within the region of interest at the different time.

In some embodiments, the method further comprises determining that the region of interest indicated by the user input is devoid of any object. In some embodiments, identifying the object of interest based on the query comprises identifying an object present within the region of interest at a different time than a time associated with the query and assigning the object of interest as the object present within the region of interest at the different time.

In some embodiments, identifying the object present within the region of interest at the different time comprises searching the object stream data store for at least one of a previous time prior to the time associated with the query for an exit of the object and a future time subsequent to the time associated with the query for an entry of the object.

In some embodiments, searching the object stream data store comprises searching within a predetermined threshold duration from the time associated with the query.

In some embodiments, identifying the object present within the region of interest at the different time than the time associated with the query comprises searching through the object stream data store to identify the object based on location information stored in the plurality of object-based metadata records.

In some embodiments, searching through the object stream data store to identify the object based on location information stored in the plurality of object-based metadata records comprises: identifying an image space coordinate within the video image associated with the user input; translating the image space coordinate to location coordinates representative of a location of interest within the scene captured by the camera; and searching through the object stream data store to identify the object based on the location information stored in the plurality of object-based metadata records being indicative of the object having been present at the location of interest.

In some embodiments, obtaining the additional information pertaining to the object of interest comprises obtaining one of an entry time at which the object of interest entered the region of interest and an exit time at which the object left the region of interest.

In some embodiments, the method further comprises presenting, via the graphical user interface, a portion of the video images captured by the camera associated with the one of the entry time and the exit time.

In some embodiments, obtaining the additional information pertaining to the object of interest comprises obtaining one or more of identity information relating to the object of interest, access control information relating to the object of interest, sighting information relating to the object of interest, and proximity information relating to the object of interest.

In some embodiments the method further comprises presenting the additional information in association with a visual representation of the object of interest.

In some embodiments, the user input indicative of the query is obtained within a first region of the graphical user interface. In some embodiments the method further comprises presenting the additional information in a second region of the graphical user interface.

In some embodiments, the method further comprises displaying, within the first region of the graphical user interface, the video image.

In some embodiments, presenting the additional information comprises modifying at least a part of the graphical user interface to facilitate presentation of the additional information.

In some embodiments, identifying the object of interest comprises determining a type associated with the object of interest. In some embodiments, the method further comprises modifying the at least the part of the graphical user interface based on the type of the object of interest.

In some embodiments, obtaining the user input comprises determining a type associated with the query. In some embodiments, the method further comprises modifying the at least the part of the graphical user interface based on the type of the query.

Another aspect of the present disclosure provides a method of operating a computing apparatus. The method comprises: obtaining, via a graphical user interface, user input indicative of a query relating to a video image frame of a scene captured by a camera; accessing an object stream data store comprising a plurality of metadata records, each metadata record of the plurality of metadata records associated with a corresponding object depicted in the video image frame captured by the camera and comprising an object identifier (ID) and one or more object attributes associated with the corresponding object; identifying, based on the query, an object of interest from amongst objects depicted in the video image frame captured by the camera, the object of interest associated with a particular metadata record; obtaining, from the object stream, additional information pertaining to the object of interest; and presenting, via the graphical user interface, at least the additional information.

### BRIEF DESCRIPTION OF THE DRAWINGS

Reference will now be made, by way of example, to the accompanying drawings which show example embodiments of the present application, and in which:

FIG. 1A depicts an object-based metadata database in accordance with a non-limiting example embodiment;

FIG. 1B depicts an object-based metadata database in accordance with an alternative non-limiting example embodiment;

FIG. 2A is a block diagram of an example architecture for conducting a forensic video investigation in accordance with a non-limiting example embodiment;

FIG. 2B is a block diagram illustrating signal flows among components of the example architecture of FIG. 2A;

FIG. 2C is a block diagram illustrating signal flows among components of a variant of the architecture of FIG. 2A;

FIG. 3A is a block diagram of a server storing a conversion program for generating contents of the object-based metadata database of FIG. 1A or FIG. 1B from contents of a temporal metadata database, in accordance with a non-limiting embodiment;

FIG. 3B illustrates the temporal metadata database used by the conversion program of FIG. 3A, in accordance with a non-limiting embodiment;

FIG. 3C is an example image database stored in an image database management system of FIGS. 2A and 2B;

FIG. 3D is an example object-based metadata record generated by the server of FIG. 3A;

FIG. 3E is another example object-based metadata record generated by the server of FIG. 3A;

FIGS. 4A-4B illustrate a flowchart illustrating a method corresponding to steps of a conversion algorithm encoded by the conversion program, in accordance with a non-limiting example embodiment;

FIG. 5A is a block diagram of an architecture for conducting a forensic video investigation, in accordance with an alternative non-limiting example embodiment;

FIG. 5B is a block diagram illustrating signal flows among components of the architecture of FIG. 5A;

FIG. 6 is a block diagram of components in the architecture of FIG. 2A or FIG. 5A in the context of an investigation process, in accordance with a non-limiting example embodiment;

FIG. 7 is a block diagram illustrating signal flows related to the investigation process among components in the architecture of FIG. 2A or FIG. 5A;

FIG. 8A is an example user interface of a user device of FIG. 2A or FIG. 5A where a simple search option is selected;

FIG. 8B is an alternative example user interface of a user device of FIG. 2A or FIG. 5A where a field search option is selected;

FIG. 9 is an example user interface of a user device of FIG. 2A or FIG. 5A where a search result is displayed in response to input from a user;

FIG. 10 is a block diagram of an example processing system suitable for implementing various functions of the server or a camera in the architecture of FIG. 2A or 5A;

FIG. 11 is a block diagram of an example processing system suitable for implementing a user device in the architecture of FIG. 2A or 5A; and

FIG. 12 is a block diagram illustrating signal flows related to identification and storage of a thumbnail image, in accordance with a non-limiting example embodiment.

FIG. 13 illustrates a flowchart illustrating a method in accordance with a non-limiting example embodiment.

FIG. 14 is an example user interface in accordance with a non-limiting example embodiment.

FIG. 15 depicts an object stream database in accordance with a non-limiting example embodiment.

FIG. 16 depicts another object stream database in accordance with a non-limiting example embodiment.

FIG. 17 is a block diagram of components of a server architecture in accordance with a non-limiting example embodiment.

Similar reference numerals may have been used in different figures to denote similar components.

In the drawings, embodiments are illustrated by way of example. It is to be expressly understood that the description and drawings are only for purposes of illustrating certain embodiments and are an aid for understanding. They are not intended to be a definition of the limits of the invention.

### DESCRIPTION OF EXAMPLE EMBODIMENTS

The present disclosure is made with reference to the accompanying drawings, in which certain embodiments are shown. However, the description should not be construed as being limited to the embodiments set forth herein. Rather, these embodiments are provided as examples. Separate boxes or illustrated separation of functional elements or modules of illustrated systems and devices do not necessarily require physical separation of such functional elements or modules, as communication between such functional elements or modules can occur by way of messaging, function calls, shared memory space, and so on, without any such physical separation. As such, functional elements or modules need not be implemented in physically or logically separated platforms, although they are illustrated separately for ease of explanation herein. Different devices can have different designs, such that while some devices can implement some functions in fixed-function hardware, other devices can implement such functions in a programmable processor with code obtained from a machine-readable medium.

### Object-Based Metadata Database

The present disclosure describes the creation and use of an object-based metadata database, which includes a plurality of object-based metadata records (i.e., datasets or data structures). Each object-based metadata record contains object-based metadata associated with an object identified in one or more video image frames spanning a certain period of time. The object-based metadata associated can include aggregated identification information specifying the one or more video image frames and/or the certain period of time. Use of the object-based metadata database may help to improve efficiency of a forensic investigative process which may be undertaken by an investigator or other user. In other applications, the object-based metadata database may be used to analyze object movements and trigger alerts based on the certain period of time when an object is identified.

The object-based metadata records in the object-based metadata database are structured to have the same format (i.e., are isomorphic), and each include at least an identification of a detected object considered to have certain object attributes (such as class, color, size, etc.), the values of those object attributes, and aggregated identification information for the video image frames where the detected object was identified. In one example embodiment, the identification of the detected object may include an object identifier (ID) of the detected object. In another example embodiment, the identification of the detected object may include a re-identification (ReID) vector of the detected object, wherein the ReID vector of the detected object may be used to identify objects in a deep leaning-based re-identification method. In some example embodiments, the aggregated identification information is in the form of timestamps identifying the video image frames.

As will be described in greater detail later on, the object-based metadata database facilitates forensic searching for video image frames that might contain an object having a certain specific combination of object attributes (i.e., features or characteristics) in which an investigator may be interested. The investigator simply needs to provide an input defining a combination of object attributes, and then any record associated with an object (or more than one object) having that combination of object attributes will be rapidly identified, and the associated video image frames will then be viewable by the investigator. The object-based metadata database may also facilitate the triggering of an alarm based on a specified combination of object attributes.

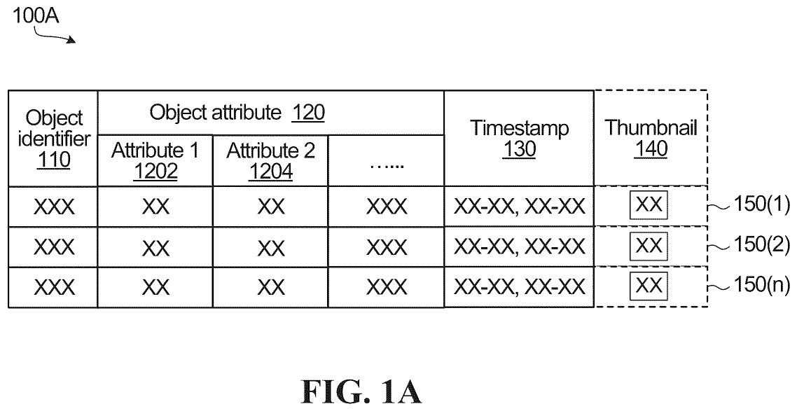

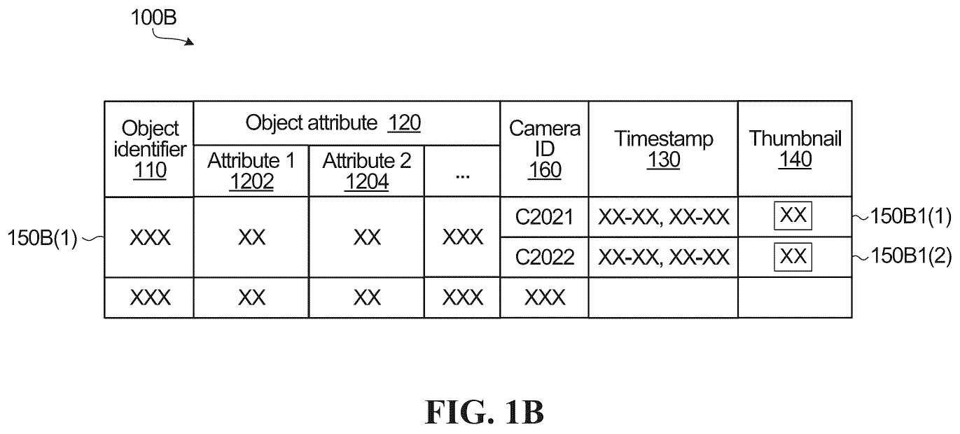

FIGS. 1A-1B present two examples of object-based metadata databases 100A, 100B (generically referred to as an object-based metadata database 100) in accordance with non-limiting example embodiments. In the example of FIG. 1A, the object-based metadata database 100A includes a plurality of object-based metadata records 150(1)-150(n) (generically referred to as object-based metadata records 150). Each of the object-based metadata records 150 in the object-based metadata database 100A may have a plurality of fields, namely an object ID field 110, an object attribute field 120, and a timestamp field 130. The object ID field 110 may include a value set (e.g., one or more alphanumeric values, a ReID vector, etc.) that identifies an object which is detected to be present in video image frames associated with aggregated timestamps in the timestamp field 130. The object attribute field 120 is indicative of object attributes of the object identified in the object ID field 110. In some examples, the object attribute field 120 may include multiple attribute sub-fields, namely a first attribute sub-field 1202, a second attribute sub-field 1204, etc.

The ranges of possible values for the various attribute sub-fields may be interdependent. To illustrate this, for example, the first attribute sub-field 1202 may be indicative of an object class of the detected object, such as whether the detected object is a vehicle or a person. In the case where the first attribute sub-field 1202 indicates that the detected object is a person, non-limiting examples of other attribute sub-fields (1204, etc.) under the object attribute field 120 may include person type (e.g., adult male, adult female, child male, etc.), clothing type, clothing color, etc. Alternatively, in case when the first attribute sub-field 1202 indicates that the detected object is a vehicle, non-limiting examples of other attribute sub-fields (e.g., 1204, etc.) under the object attribute field 120 may include vehicle type (e.g., car, truck, motorcycle, etc.), vehicle color, vehicle speed, etc.

The timestamp field 130 includes aggregated identification information associated with a plurality of video image frames deemed to contain the detected object. In particular, the timestamp field 130 is indicative of timestamp information regarding a video image frame in which the detected object first appears in a scene and timestamp information regarding a video image frame in which the detected object last appears before disappearing from the scene. In some examples, if the detected object re-appears in the video image frames being monitored, then the timestamp field 130 may include additional timestamp information regarding a video image frame in which the detected object re-appears and a video image frame in which the detected object last appears after such re-appearance. This may be the case for multiple re-appearances of the detected object, resulting in multiple additional pairs of entries in the timestamp field 130. Each such pair of entries represents a period (e.g., from appearance to disappearance) when presence of the object is detected.

In some examples, the object-based metadata record 150 may optionally include additional fields, such as a thumbnail field 140. The thumbnail field 140 may include a thumbnail image, i.e., one of the video image frames that is selected to represent the detected object (e.g., in which the detected object appears the largest or in the sharpest focus). This will be described in further detail later on.

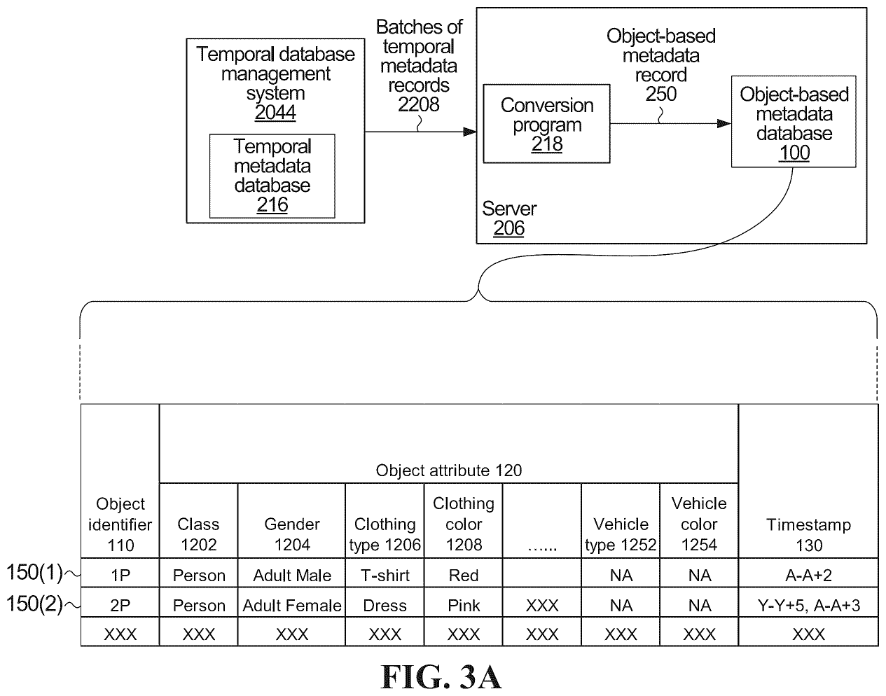

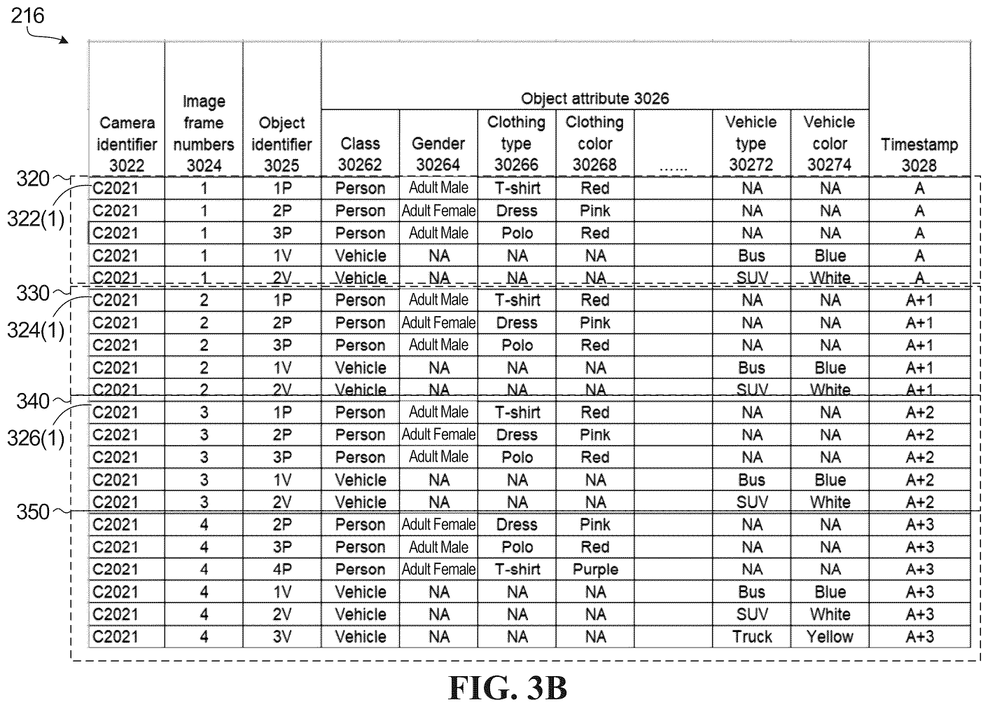

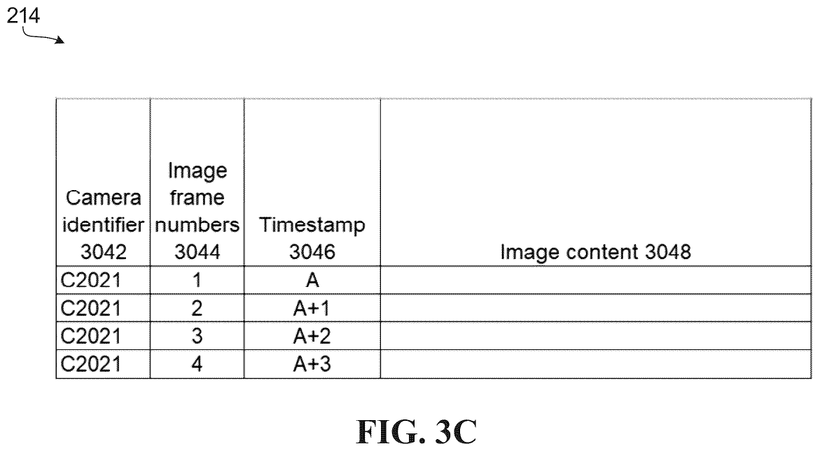

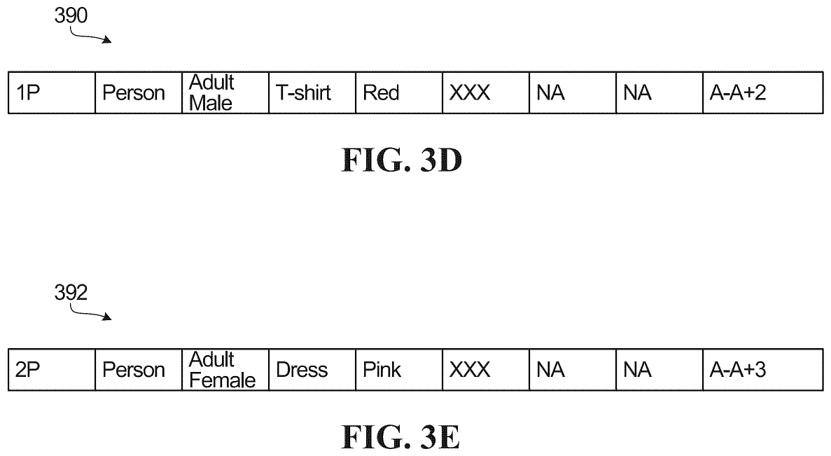

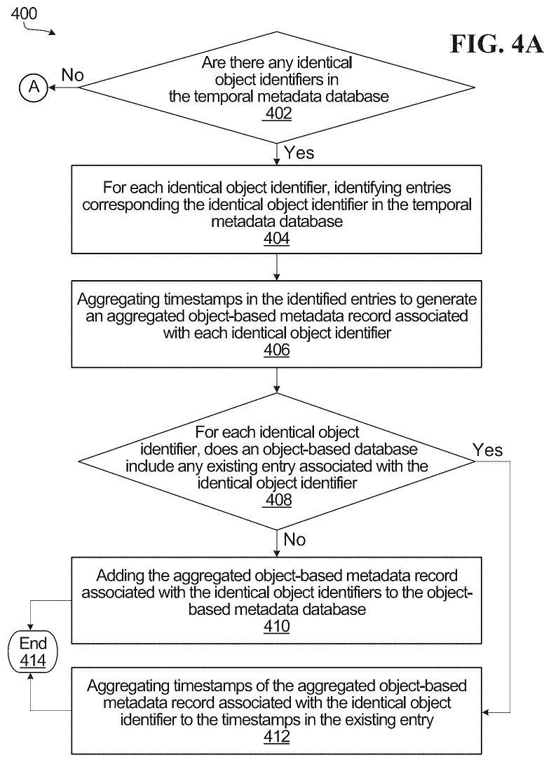

With additional reference to FIG. 3A, consider the non-limiting example object-based metadata record 150(1) for a certain detected object. The object-based metadata record 150(1) may include the following information:

$$Field 110 = \{ [ ID = 1 P ] \}$$

$$Field 120 = \{ [ class = person ] , [ \text{} person type = adult male ] , [ \text{} clothing type = T - shirt ] , [ clothing color = red ] \}$$

$$Field 130 = \{ [ \text{} timestamp of first appearance = A ] , [ \text{} timestamp of last appearance = A + 2 ] \}$$

In this example, the content of the object ID field 110 signifies that the detected object has been given an object ID “1P” which identifies this object (it should be noted that any suitable format or convention may be used for providing identifiers for objects, including unique alphanumeric codes, vector quantities, etc.). The content of the object attribute field 120 signifies that the detected object was found to have certain object attributes, which are in this case indicated in four separate attribute sub-fields 1202, 1204, 1206, 1208. Specifically, the first attribute sub-field 1202 is an object class field having a value of “person”. The other three attribute sub-fields, namely the person type field 1204, the clothing type field 1206, and the clothing color field 1208, signify other attributes associated with the “person” corresponding to the object ID “1P”.

Notably, the person type field 1204 has a value “adult male” signifying that the detected person is an adult male. To name a few non-limiting examples, other potential values for the person type field 1204 might include “adult female”, “child male”, “child female” and “infant”. In other examples, other potential values may be exist, and may include synonyms or semantic equivalents of one or more of the foregoing, or values in different languages. The clothing type field 1206 has a value “T-shirt” signifying that the detected person is wearing a T-shirt. The clothing color field 1208 has a value “Red” signifying that the color of the clothing worn by the detected person is red. In other words, the combination of object attributes 120 signifies that the detected object is an adult male wearing a red T-shirt. Finally, the content of the timestamp field 130 signifies that the detected object first appeared in a video image frame having a timestamp A and last appeared in a video image frame having a timestamp A+2.

It is noted that the object attribute field 120 includes attribute sub-fields associated with attributes related to different classes. For those attribute sub-fields unrelated to a specific class, the value of the attribute sub-fields is entered as “NA”, which means that those attribute sub-fields are unrelated to the detected object. In the example record of the object ID “1P”, values entered in a vehicle type field 1252 and a vehicle color field 1254 are “NA” because these two fields are not related to the detected object when the detected object is a person.

It should be appreciated that a detected object may be found to have other or additional object attributes. Non-limiting examples of additional object attributes associated with a person (as indicated in the class field 1202) may include hair type, hair color, facial hair, skin tone, height, estimated weight, eyewear, facial covering, head covering, upper garment type, bottom garment type, footwear style, etc. Each of these additional object attributes has a range of possible values that could be binary (e.g., yes/no, as in the case of the “face covering” or “eyewear” attributes), selected from a limited set of values (as in the case of the “hair color” or “upper garment type” attributes) or numeric (as in the case of the “estimated weight” or “height” attributes).

As discussed above, the object ID identifies a detected object. In some examples of implementation, there is a one-to-one correspondence between object IDs and combinations of object attributes in the object attribute field 120, i.e., any object having the exact same combination of object attributes in the object attribute field 120 will have the same object ID and vice versa. Stated differently, in such examples of implementation, uniqueness of the object ID is tied to the underlying combination of attributes in the object attribute field 120. This implies that two objects having the same combination of attributes in the object attribute field 120 are considered to be the same object.

In other examples of implementation, uniqueness of the object ID is not only tied to the underlying combination of attributes in the object attribute field 120, but also to hidden factors that can be obtained from image processing of the scene, but do not appear in the object attribute field 120. For example, the hidden factors could include location, time of first identification, speed, gait, behavior, etc. The hidden factors could also include object attributes that could have been part of the object attribute field 120 but are reserved for creation of the user ID. This technique allows the creation of unique object IDs for different objects that may otherwise have the same combination of object attributes in the object attribute field 120.

In still other examples of implementation, uniqueness of the object ID is tied to data that is uniquely associated with the object. For example, in an access control system, detecting an employee badge passing through a particular detector provides unique identification information (e.g., the employee ID). The employee ID can then be used, in part, to formulate a unique object ID for that specific person. Here again, unique object IDs will be created for different objects (in this case, people) that otherwise have the same combination of object attributes in the object attribute field 120. Analogously, a detected license plate number can be used, in part, to formulate a unique object ID for the detected vehicle.

FIG. 1B shows an alternative example of an object-based metadata database 100B in accordance with a non-limiting example embodiment. In this example, the object-based metadata database 100B provides an optional camera identifier (ID) field 160. The value in the camera ID field 160 corresponding to a record associated with a particular object specifies an identifier of a camera that captures the particular object. In a scenario where multiple cameras have the potential to capture the same object (either simultaneously or at different times), the two or more cameras may implement identical image processing algorithms or may have identical configurations (e.g., software and/or hardware) such that object IDs corresponding to a common object are produced to be identical. In that case, for a record 150B(1) corresponding to a common object ID, multiple sub-records (e.g., sub-records 150B1(1), 150B1(2)) may be included in the record 150B(1) for the common object ID. Each of these sub-records specifies aggregated timestamps for a respective camera (specified in the camera ID field) and may include a thumbnail image associated with the respective camera.

It should be understood that since the object ID uniquely identifies a detected object, the two or more cameras may be configured to communicate with one another to resolve any ambiguities and ensure that the same object ID will be generated when the same object is detected to be in the field of view of any of the cameras. In some examples, the two or more cameras may belong to an identical surveillance network, which may facilitate combining metadata and/or resolving any ambiguities. In addition, the two or more cameras may be configured to communicate with one another to exchange access control information and/or to assign an object ID to a detected object.

### Investigation Architecture

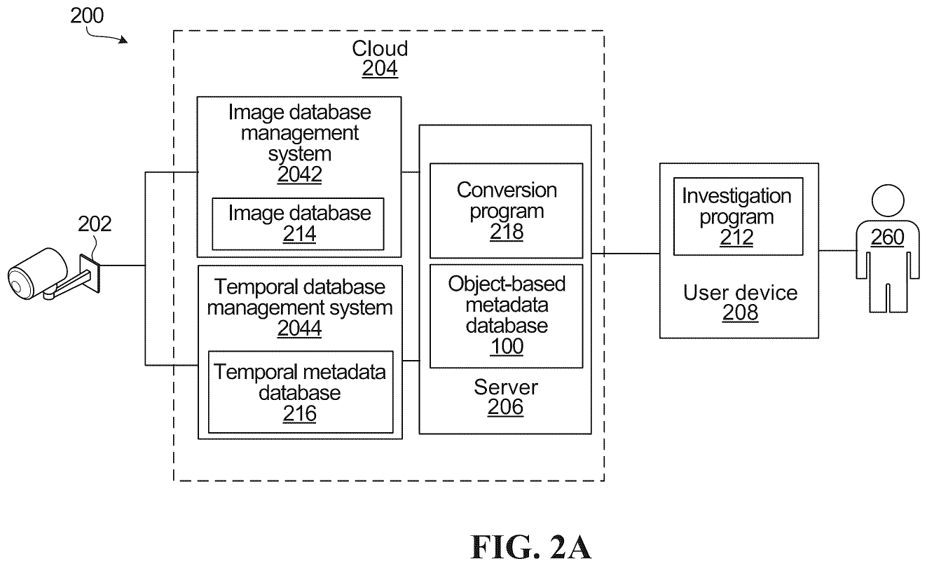

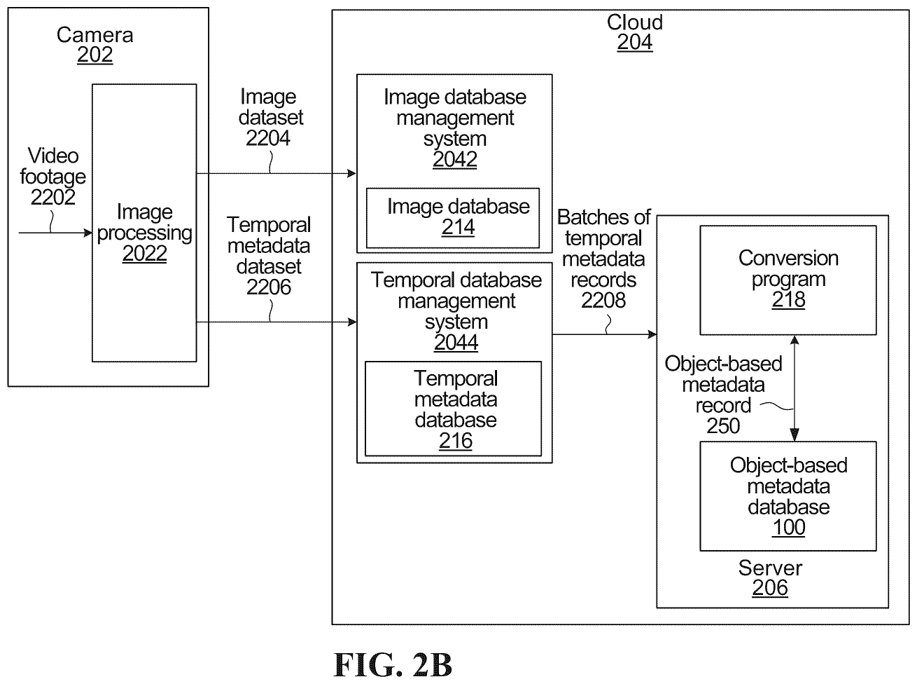

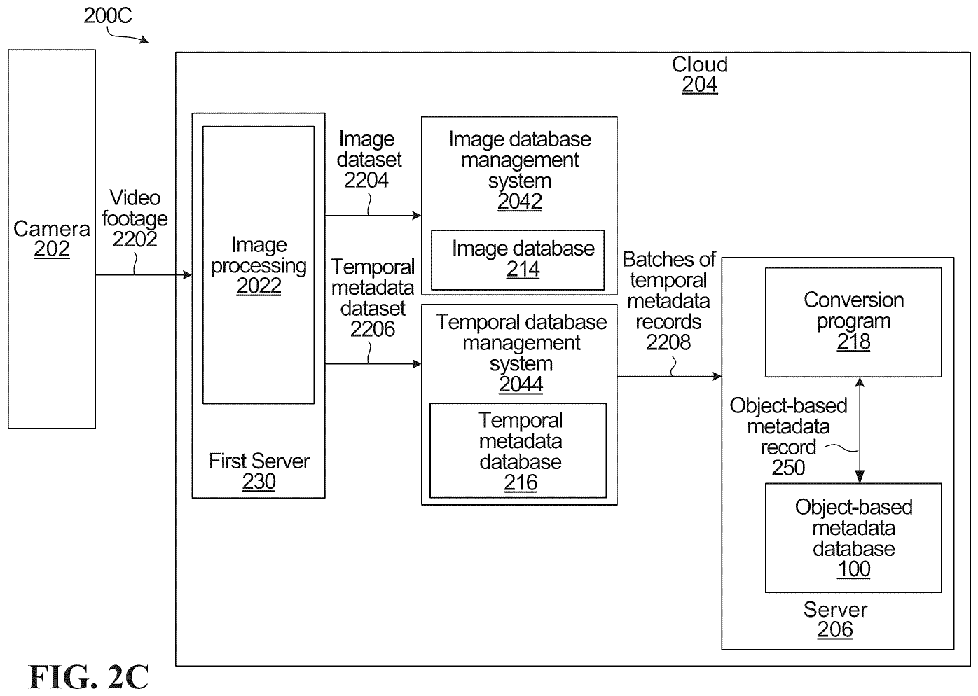

FIG. 2A is a schematic diagram illustrating an example investigation architecture 200 in accordance with a non-limiting example embodiment. The architecture 200 includes at least one camera 202 for capturing video footage of a scene, a user device 208 and a cloud 204 for communicating with the camera 202 and/or the user device 208 and for facilitating communication between the camera 202 and the user device 208. The user device 208 is configured to interact with a user 260, and stores or has access to an investigation program 212 which, when executed, allows the user 260 to conduct forensic investigations based on video analysis e.g., via a graphical user interface.

The cloud 204 includes an image database management system 2042 storing or having access to an image database 214, a temporal database management system 2044 storing or having access to a temporal metadata database 216, and a server 206 storing or having access to an object-based metadata database 100 (e.g., the object-based metadata database 100A or 100B). The server 206 stores or has access to a conversion program 218 which, when executed, generates or updates object-based metadata records in the object-based metadata database 100.

In this architecture 200, entities may communicate amongst one another via wireless connections and/or wired connections. The camera 202 may be connected separately to the image database management system 2042 and the temporal database management system 2044, or the camera 202 may be connected to a single gateway (not shown) in the cloud 204, which then establishes a connection with the image database management system 2042 and the temporal database management system 2044. In another embodiment, the camera 202 connects to the image database management system 2042 and the temporal database management system 2044 via the server 206.

### Generation/Update of Object-Based Metadata Records

Reference is now made to FIG. 2B, which illustrates an example of signal flow among selected components of the example investigation architecture 200 of FIG. 2A, namely the camera 202, the image database management system 2042, the temporal database management system 2044, and the server 206. This signal flow represents generation and/or updating of object-based metadata records in the object-based metadata database 100.

In particular, the camera 202 captures video footage 2202 in an area where the camera 202 is mounted. The camera 202 thus creates an image dataset 2204 for each captured video image frame and sends the image dataset 2204 to the image database management system 2042, either individually or in batches. The video image frames may be captured at any suitable rate, e.g., at 10 frames per second (FPS), 15 FPS, 24 FPS, 30 FPS, 60 FPS, or any other suitable rate. Video image frames captured by the camera 202 may be transmitted from the camera 202 to the image database management system 2042 at any suitable rate, e.g., once per second, more than once per second, or less than once per second. The rate at which video image frames are captured by the camera 202 need not correspond to the rate at which video image frames are transmitted to the image database management system 2042. The frame type of the video image frame may be a full frame or a partial frame, and indeed the camera may produce both full frames and partial frames, as appropriate. In some examples, the full frame may include an i-frame, a reference frame, or another suitable frame. In alternative examples, the partial frame may include a p-frame, a b-frame, etc. The image dataset 2204 includes identification information (e.g., a corresponding image frame number and a corresponding timestamp) and actual image content for each video image frame. In some applications, the actual image content may be encoded in a base64 format and included with the image data set 2204 to be sent out together.

The image database management system 2042 receives the one or more image datasets 2204 and then stores the received one or more image datasets 2204 in an image database 214 (e.g., in the form of records). An example of the image database 214 is presented in FIG. 3C. The image database 214 includes a plurality of records each having a camera ID field 3042, an image frame number field 3044, a timestamp field 3046 and an image content field 3048. Each record in the image database 214 is associated with a video image frame. For a given record in the image database 214, the image content field 3048 stores the associated video image frame itself. The image frame number field 3044 specifies a unique number/identifier of the associated video image frame. The camera ID field 3042 specifies (e.g., by way of a unique identifier) which camera captured the associated video image frame. The timestamp field 3046 signifies a timestamp corresponding to the associated video image frame.

The camera 202 is also configured to perform image processing on the video footage 2202 to identify and classify objects in each video image frame. Furthermore, the camera 202 may assign a respective object ID to each identified object. This information is stored in the form of a temporal metadata dataset 2206 for each detected object in each video image frame. The camera 202 is configured to send the generated temporal metadata datasets 2206 to the temporal database management system 2044. Each temporal metadata dataset 2206 may be in a format such as ONVIF® Profile M, as specified by the Open Network Video Interface Forum (onvif.org), although other formats are of course possible. The temporal metadata dataset 2206 indicates identification information (e.g., a corresponding image frame number and a corresponding timestamp) of the associated video image frame in which a given object was detected, as well as attributes and object ID associated with the detected object. The camera 202 sends the temporal metadata dataset 2206 to the temporal database management system 2044, either individually or in batches.

The temporal database management system 2044 obtains each temporal metadata dataset 2206 from the camera 202 and stores the received temporal metadata datasets 2206 in a temporal metadata database 216 (e.g., in the form of records). An example of the temporal metadata database 216 is shown in FIG. 3B, which will be discussed in further detail later on.

The temporal database management system 2044 may then supply or allow access to batches of records 2208 to the server 206 for carrying out a conversion algorithm encoded by the conversion program 218. The server 206 may perform the conversion algorithm at regular intervals, such as once per second or once per minute, or once per batch of records 2208, or any other value suited to operational requirements. In carrying out the conversion algorithm, the server 206 builds up the object-based metadata database 100 from the information in the temporal metadata database 216.

It will be understood that in a real-time environment (e.g., a live manhunt, object movement, etc.), additional temporal metadata datasets 2206 may be received from the camera 502 during execution of the conversion algorithm by the server 206. Such additional temporal metadata datasets 2206 may be entered into the temporal metadata database 216 as records, which will form the basis of future batches of records 2208. On the other hand, in a non-real-time environment (e.g., a forensic investigation after the fact), the entire contents of the temporal metadata database 216 may be represented by a single batch of records 2208.

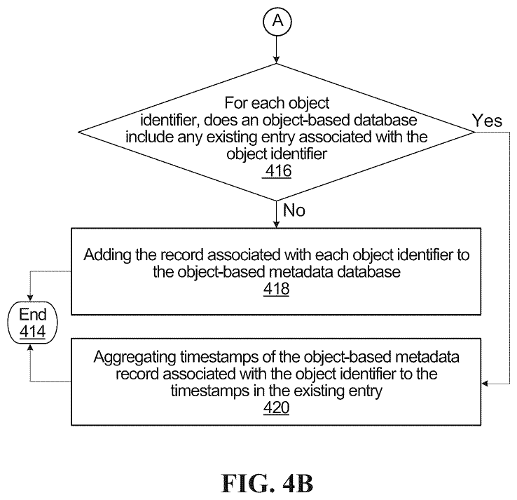

A specific example of an object-based metadata database 100 will be now described with reference to FIGS. 3A, 3B and 4 in detail.

FIG. 3A illustrates an object-based metadata database 100 containing a plurality of records, each of which is generated by the server 206 performing the conversion algorithm on records of the temporal metadata database 216, examples of which are illustrated in FIG. 3B.

In particular, with reference to FIG. 3B, each record of the temporal metadata database 216 (corresponding to one temporal metadata dataset) is associated with a detected object and an image frame. Such record in the temporal metadata database 216 (corresponding to a particular image frame and a particular detected object) comprises an image frame number field 3024 with an image frame number uniquely identifying the particular image frame, an object ID field 3025 which identifies the particular detected object, an object attribute field 3026 specifying a combination of attributes of the particular detected object, and a timestamp field 3028 signifying a timestamp of the particular image frame. In some examples, the image frame number and the timestamp of the particular image frame are jointly considered to be “identification information associated with the particular image frame”.

In the specific non-limiting example of FIG. 3B, at time A, 5 objects (i.e., with object IDs “1P”, “2P”, “3P”, “1V”, and “2V”) are detected in an image frame identified by image frame number 1. Thus, 5 records shown in a dashed box 320 are listed in the temporal metadata database 216. Values of object attributes 3026 corresponding to each detected object appear in each record. With respect to record 322(1), the values in record 322(1) represent that there exists an adult male whose object ID is “1P” wearing a red T-shirt in image frame 1. Similarly, at timestamp A+1, A+2, those 5 objects are still present in image frames 2 and 3, which are demonstrated in the dashed boxes 330 and 340. However, at timestamp A+3, there is no longer a trace of an object having object ID “1P”, whereas the other 4 objects previously detected at timestamps A, A+1, A+2 are still detected. In other words, the object ID “1P” disappears from any of the records at timestamp A+3.

Let it now be assumed that the records in the temporal metadata database 216 shown in FIG. 3B represent the batch of records 2208 processed by the server 206 in executing the conversion algorithm (encoded by the conversion program 218). In doing so, the server 206 would determine that a common object ID “1P” exist in records having timestamps A, A+1, A+2 in the temporal metadata database 216 and then aggregate those timestamps as A-A+2 and place such aggregated timestamps into the timestamp field 130 of the record 150(1) of the object-based metadata database 100 associated with object ID “P1”. Specifically, as shown in FIG. 3A, the value of the object ID field 110 in record 150(1) is “1P”, values of attribute sub-fields of the object attribute field 120 are “person”, “adult male”, “T-shirt” and “Red”, and a value of the timestamp field 130 is A-A+2. The value in the timestamp field 130 is produced by aggregating the timestamps A, A+1, A+2. The value “A-A+2” represents an aggregated time interval during which an object (e.g., in this case the object with the object ID “1P”) associated with a specific combination of attributes (e.g., in this case an adult male wearing a red T-shirt) is present in a scene.

Steps in the conversion algorithm (which may sometimes be referred to as an “aggregation algorithm”) performed by the server 206 will now be discussed with reference to a method 400 in FIGS. 4A-4B. Specifically, the method 400 results in converting data in a batch of records 2208 in the temporal metadata database 216 into data in the object-based metadata database 100. By way of non-limiting example and for the sake of illustration, consider the batch of records 2208 to be the records illustrated in FIG. 3B.

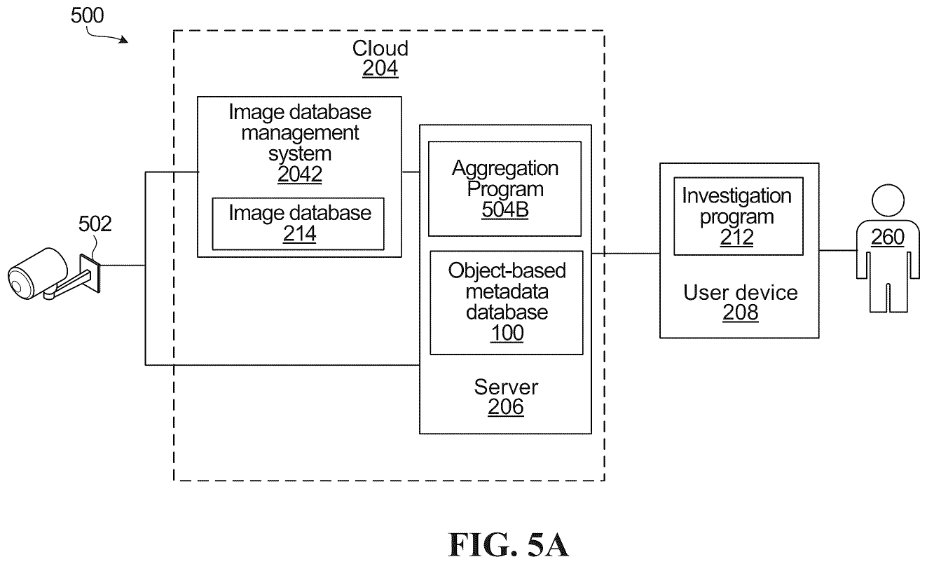

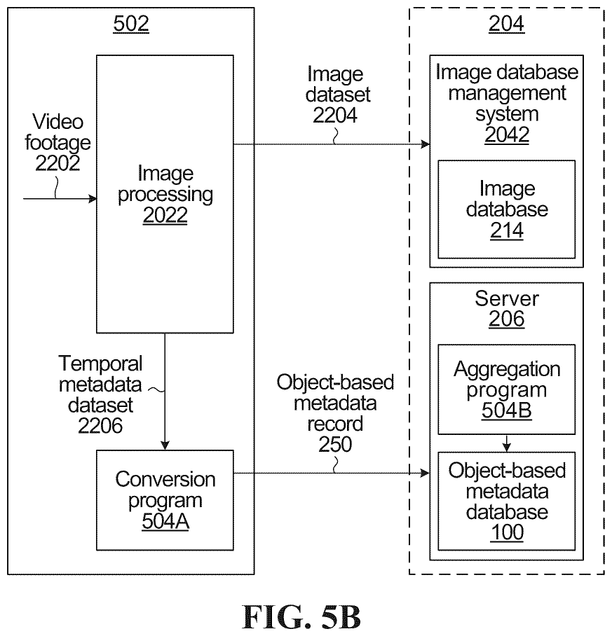

The method 400 may performed by the server 206 (see FIGS. 2A, 2B, 3A). However, this is only illustrative and is not intended to be limiting. In other examples, certain steps of the method may be performed by any other suitable entity, such as the camera 502 as shown in FIGS. 5A, 5B and later described. The method 400 can be described as follows:

Step 402: The server 206 determines if there are any records in the batch of records 2208 that share a common object ID. For instance, in this example, the server 206 determines if any common object IDs exist among the various records shown in FIG. 3B. After analyzing values in the object ID field 3025, the server 206 may find that multiple records share a common object ID, in which case the next step is step 404. For example, in this case, records 322(1), 324(1), 326(1) include an object ID “1P”. However, if the server 206 determines that the records in the batch of records 2208 do not include any common object ID, the method 400 will perform steps 416-420.

Step 404: since there are common object IDs shared by one or more records in the batch of records 2208, then for each such identical common object ID, the server 206 identifies records in the batch of records 2208 corresponding to the common object ID. For instance, in this example, with respect to the object ID “1P”, records 322(1), 324(1), 326(1) are all identified to include this object ID.

Step 406: the server 206 aggregates timestamps in the identified records (see step 404) to generate an aggregated object-based metadata record associated with each common object ID. In particular, for the object ID “1P”, the server 206 aggregates the values (e.g., A, A+1, A+2) in the timestamp field 3028 of the records in FIG. 3B to generate an aggregated object-based metadata record.

FIGS. 3D and 3E show examples of aggregated object-based metadata records 390 and 392, respectively. As demonstrated in FIGS. 3D-3E, timestamps corresponding to a common object ID spanning over a plurality of image frames are aggregated. In particular, for the object ID “1P”, the aggregated object-based metadata record 390 shows an aggregated timestamp A-A+2, during which an object identified by the unique object ID “1P” is present in the scene. Similarly, for object ID “2P”, A-A+3 is an aggregated timestamp in the aggregated object-based metadata record 392.

Step 408: for each common object ID, the server 206 may access the object-based metadata database 100 to determine whether the object-based metadata database 100 already includes any existing record associated with that object ID. If so, this would signify that an object having that object ID was already detected as having appeared in the scene and then disappeared. To this end, once the aggregated object-based metadata records 390 and 392 are generated, the server 206 may then access the object-based metadata database 100 (which may be stored in the server 206 locally or otherwise accessible via the cloud 204) to search for any record that has the object ID “1P” and any record that has the object ID “2P”.

Step 410: since this step is entered when it is determined that the object-based database 100 does not include any existing record associated with the common object ID determined at step 402, the server 206 will add the aggregated object-based metadata record to the object-based metadata database 100 as a new record. With respect to the aggregated object-based metadata record 390 of FIG. 3D, the server 206 did not find any existing record associated with object ID “1P”. Thus, the server 206 adds the aggregated object-based metadata record 390 to the object-based database 100 as a new record 150(1), as shown in FIG. 3A.

Step 412: since this step is entered when the object-based database 100 includes an existing record associated with the common object ID identified at step 402, the server 206 will re-aggregate timestamps in the aggregated object-based metadata record with timestamps in the existing record of the object-based metadata database. For ease of illustration, timestamps in the aggregated object-based metadata record are referred to as newly aggregated timestamps, and timestamps in the existing record of the object-based metadata database are named as previously aggregated timestamps.

In the example of the aggregated object-based metadata record 392 shown in FIG. 3E, the server 206 analyzes the records in the object-based database 100 and determines that an existing record in the object-based database 100 is associated with the object ID “2P”. Therefore, the server 206 will then re-aggregate the newly aggregated timestamp in the aggregated object-based metadata record 392 with the previously aggregated timestamp in the existing record in the object-based database 100. Accordingly, the server 206 produces an updated object-based metadata record which includes the newly aggregated timestamps and the previously aggregated timestamps corresponding to the object ID “2P”. As shown in FIG. 3A, the updated record 150(2) is a result of re-aggregation where the newly identified timestamps A-A+3 corresponding to object ID “2P” in the aggregated object-based metadata record 392 are aggregated with the previously identified timestamps Y-Y+5 such that a value of the timestamp field 130 represents all the timestamps when the object ID “2P” is/was present in the scene.

In a case where a plurality of cameras is disposed in an area of neighborhood, each camera may implement an image processing algorithm (such as object detection and object classification) based upon captured video footage separately. Thus, an object ID might be camera-specific, which may depend on a camera-specific term or camera specifications. This could mean that an identical object detected by two cameras will have two different object IDs. In that case, aggregation cannot be implemented with respect to the identical object due to there being two different object IDs generated by the two cameras. In such scenarios, to enable aggregation, the cameras may implement a process for assigning camera IDs that may be camera-agnostic or collaborative (i.e., dispute resolution between the cameras) in order to allow object IDs corresponding to an identical object to be same (although still unique within the investigation architecture). Thus, the object IDs corresponding to the identical object are modified to an identical object ID. The modified object ID might be system-unique or server-unique. The term “system-unique” means that the modified object ID associated with an identical object is unique and is determined based on a specific system (e.g., system specifications or configurations) within the investigation architecture. The term “server-unique” means that the modified object ID associated with an identical object is unique and depends on a specific server (e.g., server specifications or configurations) in the investigation architecture, such as a specific server communicating with the plurality of cameras in the area of neighborhood.

Step 414: the method 400 proceeds to step 414, which is executed to end the method. In particular, once the adding step 410 or the re-aggregation at step 412 is completed, the method 400 proceeds step 414.

Step 416: if the server 206 determines that the records in the batch of records 2208 do not include any common object ID, the server 206 accesses the object-based metadata database 100 to determine whether the object-based metadata database 100 already includes any existing record associated with this object ID. If it is determined that there is no existing entry associated with the object ID, the method will proceed to perform step 418 which is detailed below. If it is determined that there exists any entry associated with the object ID, the method will proceed to perform step 420 which will be described further below.

Step 418: if it is determined at step 416 that there is no existing entry associated with the object ID, the server 206 will add the record associated with the object ID as a new entry to the object-based metadata database directly. Then the method proceeds to step 414 and then ends as a result of having executed step 414.

Step 420, if it is determined at step 416 that there already exists an entry associated with the object ID in the object-based metadata database, the server 206 will aggregate timestamps of the record associated with the object ID to the timestamps in the existing entry. Once step 420 is implemented, then the method will perform step 414 to end.

Since timestamps corresponding to a common object ID are aggregated into a single object-based metadata record for that object ID, such aggregation and/or re-aggregation may enable a frame-based metadata database (i.e., each record is generated per frame, such as records in the temporal metadata database 216 in FIG. 3B) to be converted to an object-based metadata database (i.e., each record is related to an object, such as records in the object-based metadata database 100 as shown in FIG. 3A). In other words, aggregating the timestamps enables all the timestamps when an object is present in a scene to be merged into a single record for that object. In the example of record 150(2) of the object-based metadata database 100 in FIG. 3A, the value of the aggregated timestamp field 130 is “Y-Y+5, A-A+3”, which represents that an adult female wearing a pink dress who is uniquely identified with the object ID “2P” is present in the scene twice. For the first time, she first appears at timestamp Y and disappears at timestamp Y+5. For the second time, she appears again at timestamp A and disappears at timestamp A+3.

The structured object-based metadata database described herein may enable all the timestamps when an object is present to be extracted accurately if an investigator is interested in that object. Thus, tedious review of the entire video footage to extract all the timestamps when an object of interest is present may be avoided during investigation. Accordingly, efficiency of an investigative process may be improved significantly.

As such, it will be appreciated that a method of operating a computing apparatus has been described and illustrated. The method comprises accessing a plurality of temporal metadata datasets. Each of the temporal metadata datasets is associated with a video image frame of a scene and includes (i) identification information for that video image frame; (ii) an object identifier (ID) for each of one or more objects detected in that video image frame; and (iii) one or more object attributes associated with each of the one or more objects detected in that video image frame. The method further comprises, for each of one or more particular objects having a respective object ID, identifying a subset of temporal metadata datasets in the plurality of temporal metadata datasets each of whose object ID matches the respective object ID of the particular object. Furthermore, the method comprises processing the temporal metadata datasets in the subset of temporal metadata datasets in order to create an object-based metadata record for the particular object. The object-based metadata record for the particular object includes (i) the respective object ID; (ii) one or more object attributes associated with the particular object; and (iii) aggregated identification information for the video image frames in which the particular object was detected. This could include indications of one or more of the video image frames or indications of time related to those frames. Finally, the method comprises causing the object-based metadata record to be stored in an object-based metadata database.

In accordance with a variant, there is enough granularity at the attribute level such that different objects are uniquely associated with different combinations of attributes. In other words, there are enough attributes and possible values of each attribute to obviate the need for an object ID. For such a variant, the aforementioned method would be adapted as follows:

A plurality of temporal metadata datasets is accessed. Each of the temporal metadata datasets is associated with a video image frame of a scene and includes (i) identification information for that video image frame; and (ii) one or more object attribute combinations respectively associated with one or more objects detected in that video image frame. An object ID is unnecessary. Then, a particular combination of attributes is selected. For this particular combination of object attributes, a subset of temporal metadata datasets in the plurality of temporal metadata datasets is identified, namely the ones that include an object attribute combination that matches the particular combination of object attributes. The temporal metadata datasets in the subset of temporal metadata datasets are processed to create an object-based metadata record for the particular combination of object attributes.

It will be noted that the so-created object-based metadata record for the particular combination of object attributes includes (i) the particular combination of object attributes; and (iii) aggregated identification information for the video image frames in which an object having the particular combination of object attributes was detected. The method finally comprises causing the object-based metadata record to be stored in an object-based metadata database.

As mentioned above, in some applications, the records of the object-based metadata database 100 (e.g., the object-based metadata records 150) may include an optional thumbnail field, such as the thumbnail field 140 shown in FIG. 1A. The thumbnail field 140 of a record associated with a particular object may contain one or more thumbnail images, e.g., the particular video image frame in which the particular object appears the largest or in the sharpest focus. It should be appreciated that the thumbnail image may be a cropped image, or in which the object is isolated or emphasized.

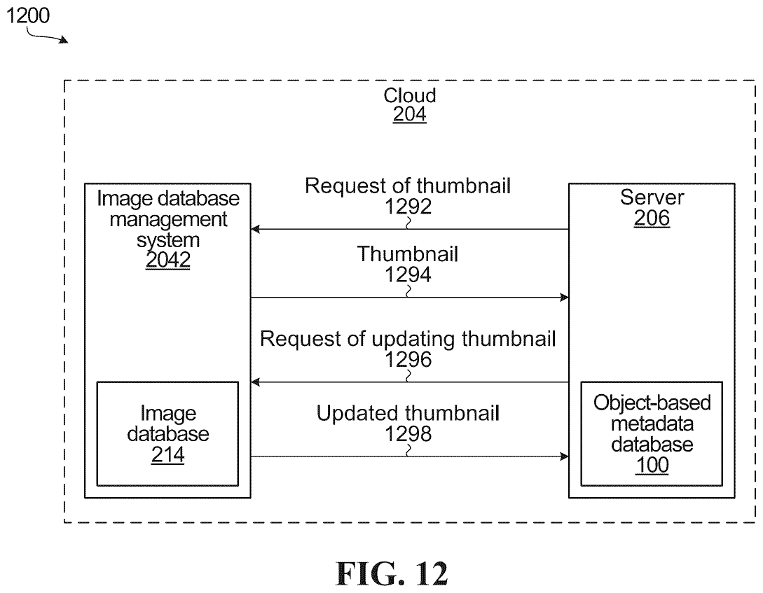

With reference to FIG. 12, the thumbnail image may be obtained as a result of communications 1200 between the sever 206 and the image database management system 2042. Such communications may include:

Step 1292: when an object-based metadata record (i.e., a particular record associated with a particular object) is to be added to the object-based metadata database 100, the server 206 requests a thumbnail image from the image database management system 2042. The request includes the aggregated timestamps from the object-based metadata record which indicate when the particular object is present in the scene. In some applications where the image database management system 2042 is a system managing image information from a plurality of different cameras, rather than a system per camera, the request may additionally comprise a camera ID which specifies a particular camera that the object-based metadata record is coming from.

Step 1294: the image database management system 2042 consults the image database 214 (containing video image frames) and performs an image processing algorithm on the video image frames associated with the received aggregated timestamps. The image processing algorithm is designed to select a reference image that is considered to best represent the particular object, e.g., in terms of size (percentage of the image occupied) or sharpness/focus. The image database management system 2042 may send the reference image to the server 206, which saves the reference image as the thumbnail image for the corresponding object-based metadata record.

Step 1296: in another example of implementation, the object-based metadata database 100 may be updated as newly aggregated timestamps are re-aggregated into previously aggregated timestamps. In that case, the server 206 may send a request to update a thumbnail image to the image database management system 2042. The request comprises updated aggregated timestamps associated with the object, which includes the newly aggregated timestamps and the previously aggregated timestamps.

Step 1298: the image database management system 2042 searches the image database 214 based on the updated aggregated timestamps. A plurality of video image frames associated with the updated aggregated timestamps are extracted and analyzed such that a new reference image among the plurality of extracted video image frames is generated, which best represents the particular object among the plurality of extracted video image frames. In some cases, the new reference image may be the previous reference image because that reference image still best represents the particular object. In other cases, the new reference image may differ from the previous reference image as newly captured video image frames may have the object in better focus, or the object may appear bigger or closer. The image database management system 2042 then sends the new reference image to the server 206, which saves the new reference image as the thumbnail image (if it differs from the previous one) in the thumbnail field 140 of the corresponding object-based metadata record.

In some examples, both the new reference image and the previous one are saved as multiple thumbnail images of the particular object since both the new reference image and the previous one can be considered as “best shots” associated with the particular object. For example, the previous reference image may show a person close to a camera but a face of the person is turned away, and the new reference image may show the person whose face can be seen from the reference image but further away from the camera. Since these two images are relevant to the person, and each is a “best shot” for the person in some regard, both images are stored as multiple thumbnail images associated with the person.

In some examples, the multiple thumbnail images associated with a particular object may be stored in the server 206 in different ways. For example, the server 206 may save a predetermined number of thumbnail images collected over a span of time at regular intervals. That is, rather than saving all the received thumbnail images, the server 206 may only save received thumbnails that are separated in time by a certain minimum interval. Alternatively, the server 206 may be pre-configured to store a predetermined number of most recently received thumbnail images.

Accordingly, when the timestamp field of an object-based metadata record in the object-based metadata database 100 is updated, this may trigger the corresponding thumbnail image to be updated accordingly.

In the examples of FIGS. 2A and 2B, it was assumed that the camera 202 implements an image processing algorithm (such as object detection and object classification) based upon captured video footage 2202. However, any suitable entity in the cloud 204 that is capable of receiving the video footage 2202 may perform the task of image processing to generate the image dataset 2204 and/or the temporal metadata dataset 2206. In this regard, FIG. 2C illustrates an alternative investigation architecture 200C which includes another server 230 (also referred to as a “first server”) to implement an image processing algorithm, as opposed to such algorithm being implemented by the camera 202 in the investigation architecture 200 of FIG. 2A. In this example, the camera 202 sends out the video footage 2202 directly without any processing, and the first server 230 performs the image processing (on the footage 2202) to generate the image dataset 2204 and the temporal metadata dataset 2206.

Alternatively still, the image dataset 2204 and the temporal metadata dataset 2206 may be generated by separate entities. For example, in one possible configuration, the camera 202 may assign timestamps and frame numbers to video image frames and then transmit the image dataset 2204 to the image database management system 2042. In addition, the camera 202 sends the video footage 2202 to the first server 230. Upon receipt of the video footage 2202, the first server 230 may carry out object detection and classification processes to generate the frame-based temporal metadata datasets 2206.

Elements/entities in the architecture for implementing the image extraction process, the object detection/classification method, including determining ReID vectors, and other image processing operations described herein may vary based on any suitable configuration of the architecture (e.g., configuration of the camera 202 and components in the cloud 204), and the disclosure is not limited to a particular configuration.

In a scenario where a plurality of cameras is disposed in an area, each of the cameras captures respective video footage and sends the respective video footage to the first server 230 directly. The first server 230 receives the respective video footage and may perform a machine learning algorithm (e.g., similarity search) to determine object attributes and/or calculate a value set (e.g., one or more alphanumeric values, a ReID vector, etc.) for each object in the respective video footage so as to identify identical objects across the various cameras, to which a unique object ID is assigned.

Although each of the cameras implements an image processing algorithm (such as object detection and object classification) based upon captured video footage individually, an object ID might include a camera-specific term or may be generated based on camera specifications. This could mean that, an identical object detected by two cameras will have two different object IDs. In that case, the object ID may be modified on intake to enable the object ID corresponding to an identical object to be same, although still unique within the investigation architecture.

Referring back to FIG. 2B, while the camera 202 performs the image processing 2022, the camera 202 may be able to perform tracking of a particular object. For example, the camera 202 may track timestamps for an object being detected, lost, and found again, which will be updated into the temporal metadata dataset 2206.

It should be appreciated that although the conversion program 218 is stored and implemented by the server 206 in the examples of FIGS. 2A, 2B, 3A, this is only illustrative and is not intended to be limiting. By way of non-limiting examples, the conversion program 218 may be partially stored and implemented by a camera internally, which will be now discussed in greater detail with reference to FIGS. 5A and 5B.

FIG. 5A depicts an alternative non-limiting example embodiment of an investigation architecture 500, which can also be used in forensic investigations. Components of the architecture 500 are similar to those in the architecture 200 as shown in FIG. 2A except that the conversion program 218 is split between the camera 502 and the server 206. Specifically, the camera 502 reads and executes program instructions that encode a camera-centric conversion algorithm (i.e., a conversion program 504A) to generate the object-based metadata records, and then sends out the generated records to the server 206. The server 206 reads and executes program instructions that encode an aggregation algorithm (i.e., an aggregation program 504B) for creation of the object-based metadata database 100.

Details on the camera-centric conversion algorithm performed by the camera 502 and the aggregation algorithm performed by the server 206 are now provided with additional reference to FIG. 5B.

Specifically, the camera 502 performs image processing on the footage and produces an image dataset 2204 and a temporal metadata dataset 2206 on a frame-by-frame basis. As previously described, the image dataset 2204 is sent to the image database management system 2042 and stored as records of the image database 214. However, in this specific example, the temporal metadata dataset 2206 need not be sent to a temporal database management system. Rather, the temporal metadata dataset 2206 can be stored internally by the camera (e.g., in the form of a record).

The camera 502 is further configured to perform the camera-centric conversion algorithm (encoded by the locally stored conversion program 504) on a batch of the internally stored temporal metadata datasets 2206 to generate an object-based metadata dataset 250 for each identical object ID. This involves steps 402, 404 and 406 of the conversion algorithm previously described with reference to FIG. 4A. The object-based metadata dataset 250 is sent to the server 206.

It is noted that the camera 502 may send the image datasets 2204 at a regular interval, whereas the object-based metadata datasets 250 may only be sent out on a per-batch basis, or perhaps only once the object associated with the object-based metadata record is detected as having left the scene. In other words, whereas the image datasets 2204 are sequentially and continuously generated, the camera 502 operates on batches of internally stored temporal metadata datasets 2206, which may result in the creation (and transmission) of an object-based metadata dataset 250 at a different rate. In some examples, the time between an object's disappearance from the scene and transmittal of an associated object-based metadata dataset 250 by the camera 502 may include a delay. In such cases, it should be apparent that transmission of the image datasets 2204 may be asynchronous to transmission of the object-based metadata datasets 250.

Once the object-based metadata dataset 250 for a given detected object is sent to the server 206, the camera 502 may be configured to erase the object-based metadata dataset 250 from its memory in order to save memory space.

The server 206 executes the aggregation algorithm on the object-based metadata datasets 250 received from the camera 502. This involves steps analogous to steps 408, 410 and 412 of the conversion method previously described with reference to FIG. 4A. In particular, when the server 206 receives the object-based metadata dataset 250, the server 206 may determine if the object ID in the object-based metadata dataset 250 already exists in any record in the object-based metadata database 100 stored within the server 206. If so, the server 206 may perform a re-aggregation algorithm to aggregate the timestamp information in the object-based metadata dataset 250 into the timestamp information of such existing record of the object-based metadata database. Thus, the object-based metadata database 100 is then updated as the newly detected timestamps are aggregated into timestamps of the existing record. Otherwise, the server 206 will consider the detected object as a newly detected object and then add the received object-based metadata data 250 as a new record in the object-based metadata database 100 directly.

It should be appreciated that in this scenario where the camera 502 performs the camera-centric conversion algorithm, the camera 502 may perform a first level of aggregation so as to aggregate timestamps from multiple temporal metadata datasets 2206 associated with an object into a single object-based metadata dataset 250, whereas the server 206 subsequently performs a re-aggregation program to enable all the timestamps corresponding to a single object to be saved in a single object-based metadata record, in order to avoid creating records corresponding to duplicate object IDs.

### Investigation Process

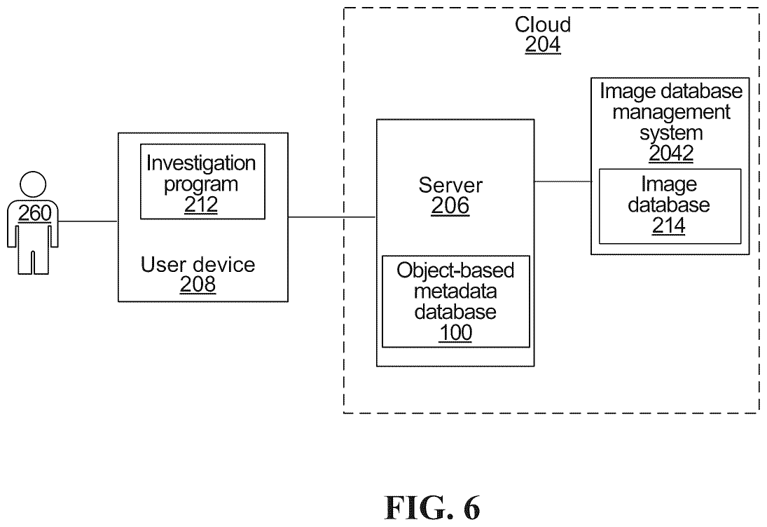

FIG. 6 illustrates key components from the investigation architecture 200, 200C, 500 involved in performing an investigation process 700 in accordance with example embodiments. These components may include the user device 208, the server 206 and the image database management system 2042.

Generally speaking, when an investigator, such as the user 260, enters input defining a combination of object characteristics (or object attributes) via the user device 208, the user device 208 communicates with entities in the cloud 204 and displays information relevant to an object, based on the communication.

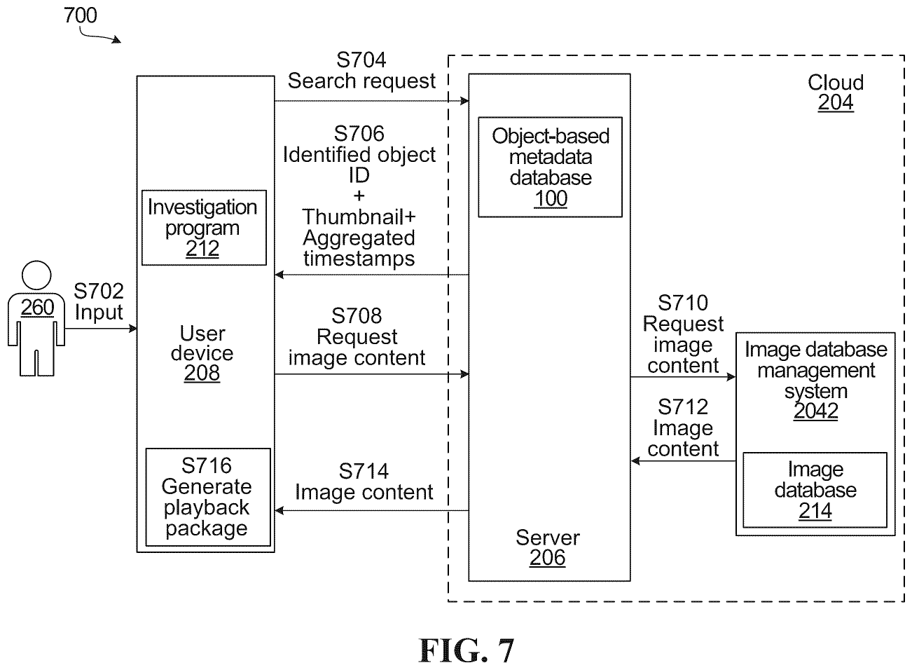

More specifically, with reference to the signal flow diagram in FIG. 7, the investigation process 700 encompasses the following steps:

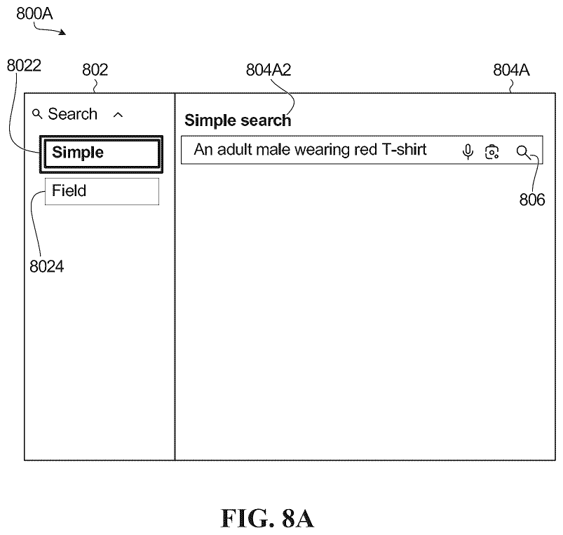

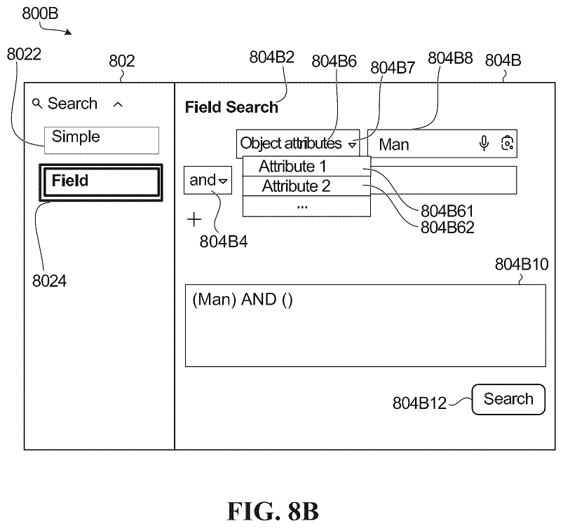

At step S702, the user device 208 receives input from the investigator 260. The input may define a combination of object attributes. The user device 208 may be a console, a mobile device, a computer or a tablet, to name a few non-limiting examples. The input may be received by the user device 208 in various ways, which will described with reference to FIGS. 8A-8B.

At step S704, the user device 208 runs an investigation program 212 to analyze the combination of object attributes and outputs a search request for information associated with the combination of object attributes. The search request is sent to the server 206 and includes the combination of object attributes.

Reference is now made to FIGS. 8A and 8B, which show an example user interface (of the user device 208) through which the user 260 can enter input (step S702 above). The user interface provides a search section 802 which includes different metadata search options, for example a simple search option 8022 and a field search option 8024. The simple search option 8022 provides an opportunity for the user 260 to enter keywords or natural language phrases, whereas the field search option 8024 provides an opportunity for the user 260 to select from pre-defined menus of words or phrases in several fields, which are connectable using user-selectable Boolean operators (e.g., AND, OR and/or NOT).

Accordingly, FIG. 8B presents an instantiation 800B of the user interface through which the user 260 enters input when the field search option 8024 is selected. There is provided a field search block 804B2 to allow the user 260 to select words or phrases from a menu of pre-defined possibilities for multiple fields. In a specific non-limiting example of implementation, an object attribute query field 804B6 may be displayed under the field search block 804B2. The object attribute query field 804B6 provides an icon 804B7. Clicking this icon 804B7 causes multiple attribute search sub-fields to appear, such as sub-fields 804B61, 804B62, each of which provides the user with an opportunity to enter in a field 804B8 a value from a corresponding menu of values. The choice of values in the menus for two or more sub-fields may be interdependent, based on the selections made by the user 260. For example, if sub-field 804B61 corresponds to the “object type” attribute, then menu 804B8 may present the choices “vehicle” and “person”, and selection of either one may condition what is permitted to be displayed in other sub-fields such as sub-field 804B62.

It should be appreciated that the field search block 804B2 may also provide a Boolean connector menu 804B4 to allow the user 260 to define how the choices of values as made in the fields 804B8 are to be logically linked. The selected values for each object attribute as well as their logical interconnection via Boolean operators may be displayed in a result query block 804B10 for the user's review. After the review, the user can click a search button 804B12 to initiate searching (step S704 above).

For example, by way of the instantiation 800B of the user interface, it may be possible for the user 260 to search for an adult male wearing a red or white T-shirt, as well as for a person of any type who is wearing something other than a T-shirt and that is not blue. Any suitable logical linkage may be permitted by the investigation program 212 to satisfy operational requirements, in order to ultimately produce a search request that includes a list of object attributes that are to be searched, either for their presence or absence.

FIG. 8A presents an instantiation 800A of the user interface through which the user 260 enters input when the simple search option 8022 is selected. There is provided a detailed display section 804A which presents a simple search block 804A2. The user 260 may input a phrase defining a combination of attributes in the simple search block 804A2. Approaches for entering the input in the simple search block 804A2 may include typing words, providing the input by voice, providing the input by image, etc. In the example of FIG. 8A, the user 260 has typed the phrase “an adult male wearing a red T-shirt” in the simple search block 804A2 and clicks a search button 806 to initiate the investigation (step S704 above). In response, the user device 260 processes the phrase to extract the object attributes of interest, in this case object class=“person”, person type=“adult male”, clothing type=“T-shirt” and clothing “color=red”.

Returning now to FIG. 7 and the description of the investigation process 700, at step S706, the server 206 returns information associated with the combination of object attributes to the user device 208 if records corresponding the combination of object attributes are found in the object-based metadata database 100. Specifically, when the server 206 receives the search request, the server 206 looks into the object-based metadata database 100 and determines if there are records corresponding to the combination of object attributes. More specifically, the server compares combination of object attributes to the contents of the object attribute field 120 of the various object-based metadata records in the object-based metadata database 100. If a match is found for one or more records (hereinafter “matching records”), information from those matching records that is associated with the combination of object attributes is returned to the user device 208.

In some examples, the information associated with the combination of object attributes includes one or more object IDs and aggregated timestamps for each object ID in the matching records. In case the records in the object-based metadata database 100 include an optional thumbnail image, the information associated with the combination of object attributes may also include a thumbnail image associated with the matching records.

At step S708, the user device 208 further sends an image content request based on the received information. Specifically, the user device 208 will have received aggregated timestamps for each object ID from the server 206 at step S706. The image content request therefore includes received aggregated timestamps. The image content request is sent to the server 206 with which the user device 208 communicates.

At step S710, once the server 206 receives the image content request from the user device 208, since the server 206 stores a network address of the image database management system 2042, the server 206 forwards the image content request to the image database management system 2042. The image content request sent to the image database management system 204 includes the aforementioned aggregated timestamps for each object ID. As such, the image content request is a request for video image frames corresponding to the aggregated timestamps for each object ID.

At step S712, in response to the image content request (including the aggregated timestamps) received from the server 206, the image database management system 2042 looks up the image database 214 extracts the video image frames corresponding to each timestamp in the aggregated timestamps. Specifically, the image database management system 2042 consults the image database 214 to identify records with a timestamp field 3046 that match the aggregated timestamps. Once these matching records are identified, the image database management system 2042 retrieves the contents of the image content field 3048 of the matching records. Thus, when the image database management system 2042 receives the image content request, one or more records in the image database 214 corresponding to the aggregated timestamps will be identified. Accordingly, one or more video image frames (referred to as “object-containing video image frames”) are extracted and sent to the server 206.

At step S714, the server 206 forwards the received object-containing video image frames to the user device 208. Of course, in some embodiments, rather than passing through the server 206, the user device 208 may directly send the image content request to the image database management system 2042 and may receive the one or more object-containing video image frames directly from the image database management system 2042.

At step S716, the user device 208 generates one or more playback packages. Each playback package includes a set of object-containing video image frames associated with an object ID demonstrating that an object associated with this object ID is present across the set of video image frames. The playback package may be represented on the user device 208 as an interactive and selectable graphical element. When the user 260 selects a specific playback graphical element, the set of video image frames associated with the object ID are played back on the screen so that the user 260 may review the contents of the set of video image frames in detail. Conventional playback control functions such as pause, rewind, skip, slow-motion, etc. can be provided by the graphical user interface of the user device 208.

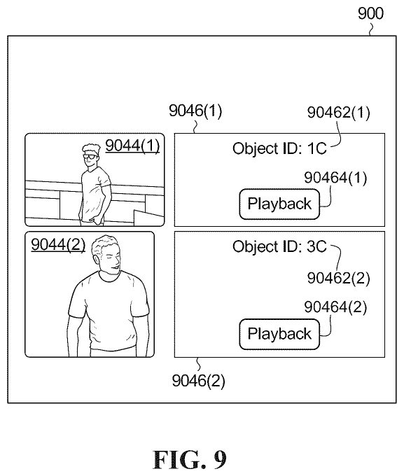

Reference is now made to FIG. 9, which shows a user interface including a results display section 900 for displaying playback packages resulting from a search request. Each playback package includes a thumbnail image and an information block, which itself includes a unique object ID and a playback element. The playback element is an interactive element which is selectable by the user. If the user is interested in investigating activities of an object, the user could select a playback element associated with the object such that all the video image frames associated with the object will be played back.

In this case, two objects matching the search request (for an adult male wearing a red T-shirt) were found. That is, although they are different objects and are associated with different object IDs, these two objects are both identified in response to the user's input because they share a combination of common attributes. Accordingly, a respective playback package associated with each of the two objects is displayed in the results display section 900. A first playback package includes a first thumbnail image 9044(1) and a first information block 9046(1). The first information block includes a unique object ID 90462(1) associated with the first object (in this case “1C”) and a first playback element 90464(1). A second playback package includes a second thumbnail image 9044(2) and a second information block 9046(2). The second information block includes a unique object ID 90462(2) associated with the second object (in this case “3C”) and a second playback element 90464(2).

In response to the user 260 selecting a specific playback graphical element, the user device 208 is configured to play back the set of object-containing video image frames associated with the object ID on the screen of the user device 208 so that the user 260 may review the contents of the set of object-containing video image frames in detail.

For example, if the user is interested in investigating the activities of the object having the object ID “3C” (and shown in the optional thumbnail image 9044(2)), the user 260 may select the playback element 90464(2) to review all the video image frames where the object ID “3C” was found to be present. Since video image frames deemed to contain this object were previously aggregated and saved together (i.e., by retrieving video image frames based on the information in an object-based metadata record associated with the object ID “3C”), those video image frames could be accessed instantaneously during the search process. Therefore, efficiency of investigation may be improved significantly.

It is noted that the thumbnail images 9044(1), 9044(2), which are optional components of the playback package, may further enhance efficiency of the investigation, as they provide a preview of the object to the user 260, allowing the user to potentially eliminate false alarms without having to select the playback graphical element and view the associated video image frames, only to discover based on other visual cues that the object was not a target of the investigation.

The investigation process 700 described with reference to FIG. 7 details how certain components in the architecture 200, 200C, 500 implement individual steps in response to a user's input (e.g., the user 260) and how one or more playback packages are generated and displayed on a user interface of the user device 208. Such investigation process enables the user to efficiently investigate activities associated with object of interest.

### Conversion Apparatus

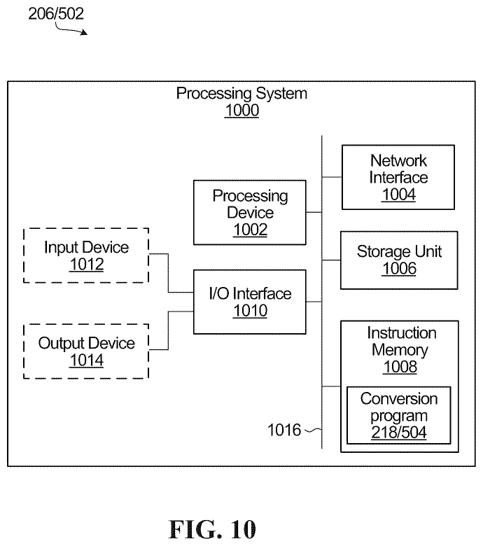

FIG. 10 is a block diagram of an example simplified processing system 1000, which may be used to store and execute the conversion program 218. The processing system 1000 may be implemented by the server 206 as shown in FIG. 2A. Although FIG. 10 shows a single instance of each component, there may be multiple instances of one or more of the components in the server 206.

The processing system 1000 may include one or more network interfaces 1004 for wired or wireless communication with other entities in the cloud 204 and/or with the user device 208. Wired communication may be established via Ethernet cable, coaxial cable, fiber optic cable or any other suitable medium or combination of media. In addition, the processing system 1000 may comprise a suitably configured wireless transceiver for exchanging at least data communications over wireless communication links, such as WiFi, cellular, optical or any other suitable technology or combination of technologies. Such wireless transceiver would be connected to the processing system 1000, specifically via the network interface 1004 of the processing system 1000.

The processing system 1000 may include a processing device 1002, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 1000 may include one or more input/output (I/O) interfaces 1010, to enable interfacing with one or more optional input devices 1012 and/or optional output devices 1014.

The processing system 1000 may also include a storage unit 1006, which may include a mass storage unit such as a solid-state drive, a hard disk drive, a magnetic disk drive and/or an optical disk drive. In some examples, the storage unit 1006 may store the object-based metadata database 100.

The processing system 1000 may also include an instruction memory 1008, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 1008 may store instructions (e.g., the conversion program 218) for execution by the processing device 1002, such as to carry out example methods described in the present disclosure. The instruction memory 1008 may store other software, such as an operating system and other applications/functions.

Additional components may be provided. For example, the processing system 1000 may comprise an input/output (IO) interface 1010 for interfacing with external elements via optional input and/or output devices 1012, 1014, such as a display, keyboard, mouse, touchscreen and/or haptic module, for example. In FIG. 10, the input and output device 1012, 1014 are shown as internal to the processing system 1000. This is not intended to be limiting. In other examples, the input and output device 1012, 1014 may be external to the processing system 1000.

There may be a bus 1016 providing communication among components of the processing system 1000, including the processing device 1002, I/O interface 1010, network interface 1004, storage unit 1006, and/or instruction memory 1008. The bus 1016 may be any suitable bus architecture including, for example, a memory bus, a peripheral bus, or a video bus.

A similar system may be implemented by the camera 502 to store and execute the conversion program 504A. In that case, the input device 1012 of the camera 502 may be an image sensor capturing video footages in an area where the camera 502 is disposed. In this example, the conversion program 504A is stored within the instruction memory 1008. Thus, in addition to carrying out the camera-centric conversion algorithm encoded by the conversion program 504A stored in the instruction memory 1008, the processing device 1002 may further perform image processing on video image frames of the video footage 2202 captured by the image sensor 1012 to identify and classify objects in the video image frames and to generate the image datasets 2204 and temporal metadata datasets 2206.

### Investigation Apparatus

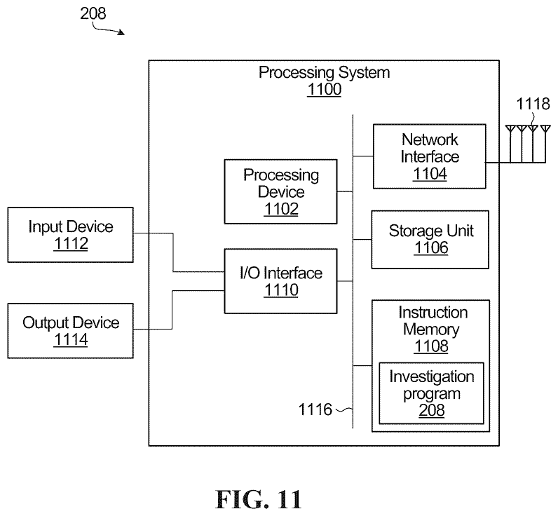

Referring to FIG. 11 now, which is a block diagram of an example simplified processing system 1100, which may be used to implement a user device, such the user device 208 of FIG. 2A. The user device 208 could be a mobile phone, tablet, console, computer, or any device that could run the investigation program 212. It is noted that although FIG. 11 shows a single instance of each component, there may be multiple instances of each component in the user device 208.

The processing system 1100 may include one or more network interfaces 1102 for wired or wireless communication with the cloud 204 or with other devices. Wired communication may be established via Ethernet cable. In addition, the processing system 1100 may comprise a suitably configured wireless transceiver 1118 for exchanging at least data communications over wireless communication links. The wireless transceiver 1118 could include one or more radio-frequency antennas. The wireless transceiver 1118 could be configured for cellular communication or Wi-Fi communication. The wireless transceiver 1118 may also comprise a wireless personal area network (WPAN) transceiver, such as a short-range wireless or Bluetooth® transceiver, for communicating with entities in the network 1104, such as the sever 206. The wireless transceiver 1118 can also include a near field communication (NFC) transceiver. The wireless transceiver 1118 is connected to a processing system 1100, specifically via a network interface 1104 of the processing system 1100.

The processing system 1100 may include a processing device 1102, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 1100 may include one or more input/output (I/O) interfaces 1110, to enable interfacing with one or more input devices 1112 and/or output devices 1114.

The processing system 1100 may also include a storage unit 1106, which may include a mass storage unit such as a solid-state drive, a hard disk drive, a magnetic disk drive and/or an optical disk drive.

The processing system 1100 may also include an instruction memory 1108, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 1108 may store instructions, such as the investigation program, which may be executed by the processing device 1102, such as to carry out example methods described in the present disclosure. The instruction memory 1108 may store other software, such as an operating system and other applications/functions.

Additional components may be provided. For example, the processing system 1100 may comprise an I/O interface 1110 for interfacing with a user (e.g., the investigator 260 of FIG. 2A) via input and/or output devices 1112, 1114. In some examples, the input device 1112 may include a speaker, an image sensor, a display, keyboard, mouse, touchscreen, haptic module, console, or any other components that have the ability to receive inputs from the user 260. In some examples, the output device 1114 may be a display or any other user interface where thumbnail images and/or playback elements are displayed.

In FIG. 11, the input and output device 1112, 1114 are shown as external to the processing system 1100. This is not intended to be limiting. In other examples, one or more of the input device 1112 and the output device 1114 may be integrated together and/or with the processing system 1100. For example, the input device 1112 and the output device 1114 may be integrated as a single component, such as a touchscreen, which may receive the user's input and display search results.

There maybe a bus 1116 providing communication among components of the processing system 1100, including the processing device 1102, input/output interface 1110, network interface 1104, storage unit 1106, and/or instruction memory 1108. The bus 1116 may be any suitable bus architecture including, for example, a memory bus, a peripheral bus or a video bus.

### Object Stream

In some embodiments, object-based metadata records described herein may be combined into an “object stream”. For example, object-based metadata records 150 corresponding to an object may be combined into an object stream corresponding to the object. An object stream described herein may be, or include, a searchable condensed data source which describes (or represents) a procession of an object (or objects) imaged (or seen) by a given camera (such as camera 202 or 502, for example). In some embodiments, the object-based metadata records corresponding to a plurality of cameras may be combined into an object stream (which may be referred to as “combining the object-based metadata records cross-camera”). In some such embodiments, the object stream may be, or may include, a searchable condensed data source which describes a procession of an object (or objects) imaged (or seen) by the plurality of cameras.

A user may interact with one or more video feeds captured by one or more cameras (such as cameras 202 or 502, for example) through a graphical user interface (GUI). In some cases, the user may interact with the video feed directly. For example, the user may interact with the video feed directly by clicking within a video tile displaying the video feed. The video feed may, for example, be a video feed of a given camera. If the object stream indicates that an object used to be present in that portion of the video, then the GUI may display those portions of the object stream to the user. If there is an object in that portion of the video, then the GUI may display other information about the object to the user. The other information may also be referred to herein as additional information. For example, the other information about the object may include information about where else the object was seen, information about when the objected entered or left the scene, etc. In some embodiments, the other information includes suggestions regarding one or more potential actions that a user may perform in response to an object being selected or queried. The one or more potential actions may, for example, include running an investigation, dispatching security personnel, raising an alarm, etc.

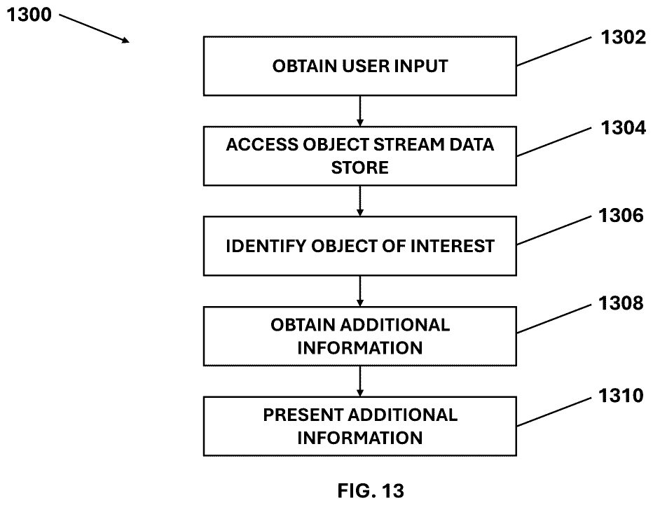

In some embodiments, a method (such as method 1300 illustrated in FIG. 13, for example) comprises: obtaining, via a graphical user interface (GUI), user input indicative of a query relating to a video image of a scene captured by a camera (e.g., see 1302 in FIG. 13); accessing an object stream data store comprising a plurality of object-based metadata records, each object-based metadata record of the plurality of object-based metadata records associated with a corresponding object depicted in video images captured by the camera and comprising at least one object stream comprising (i) an object identifier (ID) and (ii) one or more object attributes associated with the corresponding object, the object stream data store comprising aggregated identification information for video images in which the corresponding object was detected (e.g., see 1304 in FIG. 13); identifying, based on the query, an object of interest from amongst objects depicted in the video images captured by the camera, the object of interest associated with a particular object-based metadata record (e.g., see 1306 in FIG. 13); obtaining, from the object stream, additional information pertaining to the object of interest (e.g., see 1308 in FIG. 13); and presenting, via the graphical user interface, at least the additional information (e.g., see 1310 in FIG. 13). Although the user input is described as being obtained via the GUI, the user input need not be obtained via the GUI and may be obtained using an input/output device. Likewise, although the additional information may be presented via the GUI, the additional information need not be presented via the GUI (e.g., the additional information may be transmitted to a user device, the additional information may be transmitted to a computing entity for further processing, etc.).

The method may be performed by the server 206. However, this is only illustrative and is not intended to be limiting. In other examples, certain steps of the method may be performed by any other suitable computing entity.

An object identifier described herein may be or may include a unique number corresponding to an object, a unique string corresponding to an object, a hash of attributes of the object, an embedding vector for the object, etc. The object identifier may uniquely identify or represent an object.

The user input may be indicative of a selection of one of a plurality of objects depicted in the video image. User input selecting an object may identify an object as an object of interest. In some embodiments, identifying the object of interest comprises assigning the object of interest as a selected object from amongst the plurality of objects. In some embodiments, the method 1300 may support the identification of multiple objects of interest, whether based on a singular user input or based on multiple user inputs. In such embodiments, when a user has provided user input that is interpreted by the sever 206 as potentially pertaining to multiple objects of interest, the method 1300 may include presenting different possible objects of interest, or groups of objects of interest, to the user and may include soliciting further user input for clarifying which of the potential objects of interest should be assigned as the object of interest. The different possible objects of interest, or groups of objects of interest, may be presented to the user by displaying the objects of interest, or groups of objects of interest, to the user via the GUI, for example.

In some embodiments, a user may select an object by interacting with a list (e.g., a list of objects) that is displayed by the GUI. In some embodiments, the user input being indicative of the selection of the one of the plurality of objects depicted in the video image comprises the user input being an interaction with a list displayed within the graphical user interface.

A user may indicate a region of interest in the video image. In some embodiments, the user input is indicative of a region of interest in the video image. The region of interest may be a part of a video image frame or the entirety of the video image frame depending on a context of the video image. In some embodiments, the user input is indicative of an object located within the region of interest. In some embodiments, identifying the object of interest based on the query comprises assigning the object of interest as the object located within the region of interest.

The method may further comprise determining that the region of interest indicated by the user input is devoid (or clear) of any object at the time the query is provided. For the purposes herein, “devoid of any object” or “clear of any object”, may occur, or may mean, when there is no object that would be interpreted as the object of interest. For example, if the region of interest is an empty corridor, an unoccupied portion of a parking lot, a bench with nothing on it, etc. such region of interest still has objects such as a floor, walls, the bench, etc. However, in such example, since the regions of interest are empty or unoccupied, there may be no object that would reasonably be interpreted as an object of interest. Determining whether a region of interest is devoid of any object may be based on, or may include, background modelling, detection of motion compared against surrounding frames, object detection or recognition, a lack of metadata generated by the camera for an object in the frame in question, etc.

In some embodiments, identifying the object of interest based on the query comprises identifying an object present within the region of interest at a different time than a time associated with the query and assigning the object of interest as the object present within the region of interest at the different time.

In some embodiments, identifying the object present within the region of interest at the different time comprises searching the object stream data store for at least one of a previous time prior to the time associated with the query for an exit of the object and a future time subsequent to the time associated with the query for an entry of the object. In some embodiments, searching the object stream data store comprises searching within a predetermined threshold duration from the time associated with the query. The threshold may be set by a user of the system or may be a preset or default value. In some cases, the preset value may be based on the type of objects typically captured by the camera, the frequency at which objects are captured by the camera, by the nature of the scene typically captured by the camera, or the like. For instance, a camera capturing a scene of a highway or other area with fast-moving vehicular traffic may employ a comparatively shorter threshold duration for identifying the exit or entry of an object, whereas a camera capturing a scene of a food court, a corridor, or other area with slow-moving foot traffic may employ a comparatively longer threshold. Other approaches, including dynamic thresholding based on the type of user input provided may also be considered or used to determine the threshold.

In some embodiments, identifying the object present within the region of interest at the different time than the time associated with the query comprises searching through the object stream data store to identify the object based on location information stored in the plurality of object-based metadata records. In some embodiments, searching through the object stream data store to identify the object based on location information stored in the plurality of object-based metadata records comprises: identifying an image space coordinate within the video image associated with the user input; translating the image space coordinate to location coordinates representative of a location of interest within the scene captured by the camera; and searching through the object stream data store to identify the object based on the location information stored in the plurality of object-based metadata records being indicative of the object having been present at the location of interest.

The additional information pertaining to the object of interest may, for example, be obtained by obtaining one of an entry time at which the object of interest entered the region of interest and an exit time at which the object left the region of interest. A portion of the video images captured by the camera (or cameras) associated with the one of the entry time and the exit time may be presented to a user such as via the graphical user interface, for example.

Additionally, or alternatively, the additional information pertaining to the object of interest may, for example, be obtained by obtaining one or more of identity information relating to the object of interest, access control information relating to the object of interest, sighting information relating to the object of interest, and proximity information relating to the object of interest.

Identity information relating to the object of interest may be, or may include, information or one or more characteristics which identifies an object of interest. Identity information for an object that is a human may, for example, be or include hair colour, eye colour, sex, height, build, what the person is wearing, etc. Identity information for an object that is a vehicle may, for example, be or include vehicle make, model, colour, license plate, etc.

Access control information relating to the object of interest may be, or may include, information representing the object of interest's interactions with one or more access control systems. An access control system may be a system which is operable to control access to an environment such that only authorized persons can enter the environment. The access control system may include one or more devices which an object may interact with to gain access to an environment such as a key card reader operable to unlock a door when an authorize key card is detected, a license plate reader operable to open a gate when an authorized license plate is detected, etc.

Sighting information relating to the object of interest may be, or may include, information representing locations where the object of interest was observed, whether by the camera 202 (or 502) or another device. For example, the sighting information relating to a person of interest in a mall setting may indicate that the person was sighted in the parking lot as well as in front of the grocery store of the mall.

Proximity information relating to the object of interest may be, or may include, information representing objects which were nearby to the object of interest. For example, if the object of interest is a car, the proximity information relating to the car may be, or may include, persons who lingered by the car. In some cases, the proximity information is, or includes, information representing objects which were within a threshold proximity of the object of interest.

In some embodiments, the additional information may be at least partially sourced (or obtained) from a source that is outside the object stream. For example, the source that is outside the object stream may be, or may include, a data source of an access control system, a data source of an investigation system described herein, etc.

In some embodiments, the additional information may be, or may include status information. The status information may represent a status or state of an object. For example, the status information relating to a car may be whether the car is running or not. The status information relating to a light may be whether the light is on or not.

In some embodiments, the additional information may be, or may include, one or more characteristics of an object (or objects). The characteristics may represent one or more features or traits of the object(s). For example, the characteristics may be, or include, a height of a person, a make of a vehicle, a model of a vehicle, etc.

In some embodiments, the additional information may be, or may include, a trajectory of an object (which may also be referred to herein as “object trajectory”). For example, if an object is moving to the east, the object trajectory may be identified as an “eastwardly trajectory”.

In some embodiments, the additional information may be, or may include, information representing where else an object has been seen. In some embodiments, the information representing where else an object has been seen is limited to a specified time period.

In some embodiments, the additional information may be, or may include, information relating to an object or objects associated with an object of interest. For example, if the object of interest is a person, information relating to objects associated with the person may include information relating to a bag or laptop that the person was carrying. As another example, if the object of interest is a car, information relating to objects associated with the car may include information relating to a trailer being pulled by the car.

In some embodiments, the additional information may be, or may include, suggestions regarding one or more potential actions that a user may perform in response to an object being selected or queried. As described elsewhere herein, the one or more potential actions may, for example, include running an investigation, dispatching security personnel, raising an alarm, etc.

In some embodiments, the additional information is presented to the user, for instance via one or more elements forming part of the GUI, in association with a visual representation of the object of interest. The visual representation of the object of interest may be, or may include, a thumbnail image of the object of interest, for instance a best shot obtained by the camera, a context image illustrative of the environment in which the object is found, or the like. Other visual representations may include an animated image sequence (e.g., an animated Graphics Interchange Format (GIF) image, a video clip, or the like), a composite image (e.g., a collection of multiple images of the object of interest, for instance taken from different perspectives), or the like.

The GUI may include at least two regions. The user input indicative of the query may, for example, be obtained within a first region of the GUI. The additional information may be presented in a second region of the GUI. In some embodiments, the video image is displayed within the first region of the GUI.

Different types of user queries which may relate to different types of objects of interest may cause different types of results to be shown to the user. As described elsewhere herein, the user may provide user input and/or may be presented with results via a GUI. For example, if a user clicks on a person in a parking lot, then the user may be presented with similar persons, what other persons were nearby, any cars they stopped at, etc. As another example, if a user clicks on a car in the parking lot, then the user may be presented with persons who lingered by that car. In this example, similar cars would not be shown. In other words, in this example despite the user clicking on/selecting a car, the user is presented with persons who lingered by the selected car but not cars which are similar to the selected car.

In some embodiments, what the additional information is, or includes, is at least partially determined based on what data is available or what system(s) the method or the investigation system described herein may have access to. For example, if the method does not have access to an access control system, the additional information may not include access control information. As another example, if the method does not have access to a license plate reader, the additional information may not include license plate numbers. In some embodiments, what the additional information is, or includes, is varied based on what data is available or what system(s) the method of the investigation system described herein may have access to. For example, if the method had access to a license plate reader but the license plate reader becomes non-operational, the additional information may no longer include license plate numbers.

In some embodiments, additional information associated with one or more objects detected in a scene is automatically presented to a user. The additional information may be automatically presented in response to a condition being satisfied or an occurrence of an event. For example, additional information associated with one or more objects detected in a scene may be automatically presented in response to a threat level of a site that the scene corresponds to being increased.

To facilitate presentation of the additional information, at least a portion (or part) of the GUI may be modified in some embodiments. Identifying the object of interest may include determining a type associated with the object of interest. The portion of the GUI which may be modified to facilitate presentation of the additional information may be modified based on the type of the object of interest. In some embodiments, obtaining the user input comprises determining a type associated with the query. The portion of the GUI which may be modified to facilitate presentation of the additional information may be modified based on the type of the query. For example, the method may differentiate between person-type queries and vehicle type queries, and adjust the GUI according to the type of query, for instance to display different types of additional information based on the type of query. By way of another example, the method may differentiate between queries relating to objects which are present within the video image and queries relating to objects which are not present within the video image, for instance to display both entry- and exit-time information for objects present within the video image and to display only one of entry- and exit-time information for objects not present within the video image. Other approaches are also considered.

Many types of user input may be interpretable as a query.

In some embodiments, user input which includes a user clicking on a video tile (e.g., whether to identify an object or a region) may be interpretable as a query. The video tile may be presented (or displayed) by a GUI or may form part of a GUI.

In some embodiments, user input which includes a user drawing a bounding box (or other suitable bounding shape) within a video tile (e.g., whether to identify an object or a region) may be interpretable as a query. The user may draw the bounding box through interacting with a GUI, for example.

In some embodiments, user input which includes a user selecting an object that has been identified by the method (e.g., whether within a video tile or in a separate listing) may be interpretable as a query. The user may select the object through interacting with a GUI, for example.

In some embodiments, user input which includes a user interacting with playback controls associated with a video tile may be interpretable as a query. For example, when a user pauses the video, the method might automatically identify an object of interest based on which object is most prominent.

For the purposes described herein, a region of interest may also be a trajectory of interest (e.g., has any object followed this path (or a path of interest), has any object from an entry point that is of interest (in the scene) to an exit point that is of interest, etc.).

For the purposes described herein, a region of interest may also be a threshold line (e.g., has any object crossed a line of interest).

Example method 1300 illustrated in FIG. 13 will now be described in further detail.

At block 1302, method 1300 includes obtaining a user input from a user (such as a user 260, for example). The user input may indicate or represent one or more queries the user has relating to a video image of a scene captured by a camera (such as camera 202 or 502, for example). Put differently, the user input may be interpretable to ascertain the nature of one or more queries the user has relating to the video image. For example, if a camera is monitoring a bench, the user may have a query as to which persons sat on the bench within a specific time period. In some embodiments, the user input is obtained via a GUI that the user may interact with. The GUI may be presented to the user and the user may interact with the GUI via a user device (such as a user device 208, for example). For example, the user may interact with the GUI via one or more input/output (I/O) devices of the user device. In some embodiments, investigation program 212 presents the GUI to the user.

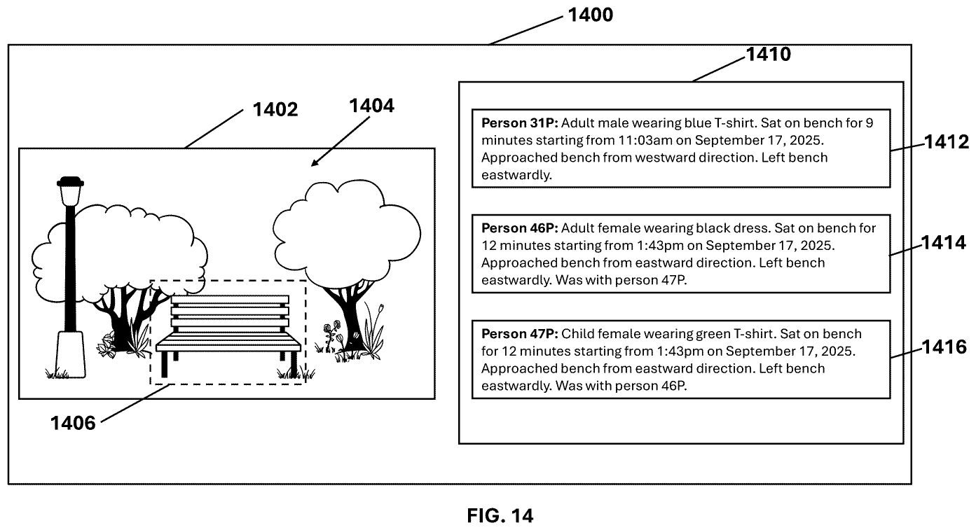

Referring to FIG. 14, an example GUI 1400 is illustrated. GUI 1400 is an example of a GUI with which a user may interact with to provide user input indicating one or more queries the user has relating to a video image of a scene captured by a camera.

The example GUI 1400 includes a video tile 1402 which is configured to display (or present) a video feed 1404. Video feed 1404 may be captured by a camera such as camera 202 or 502 described elsewhere herein, for example.

In the illustrated example of FIG. 14, the video feed 1404 is of a park bench. The video image of the video feed 1404 illustrated in FIG. 14 is also an example of a video image of a region that is devoid of any object as illustrated (i.e., although the video feed illustrates a bench, a lamp post, trees and other surrounding plants, the video image of the video feed as illustrated in FIG. 14 does not include any object that could be interpreted as the object of interest).

In the illustrated example of FIG. 14, the user provides their input (e.g., indicates their query) by drawing a bounding box 1406 which illustrates a region of interest of the video feed 1404 that the user is interested about. Method 1300 may, for example, interpret bounding box 1406 (i.e., the user input in this example) as meaning that the user is interested in finding out more about one or more objects which may have sat on the bench or have moved passed the bench.

Returning to FIG. 13, at block 1304, method 1300 may access an object stream data store. The object stream data store may include an object stream database.

The object stream database may include a plurality of object-based metadata records. Each of the object-based metadata records may be associated with a corresponding object that is depicted in video images of the video feed (e.g., video images captured by a camera capturing the video feed). Each of the object-based metadata records may also include an object stream which includes an object ID and one or more object attributes associated with the corresponding object. As described elsewhere herein, the object stream data store may include aggregated identification information for video images in which the corresponding object was detected.

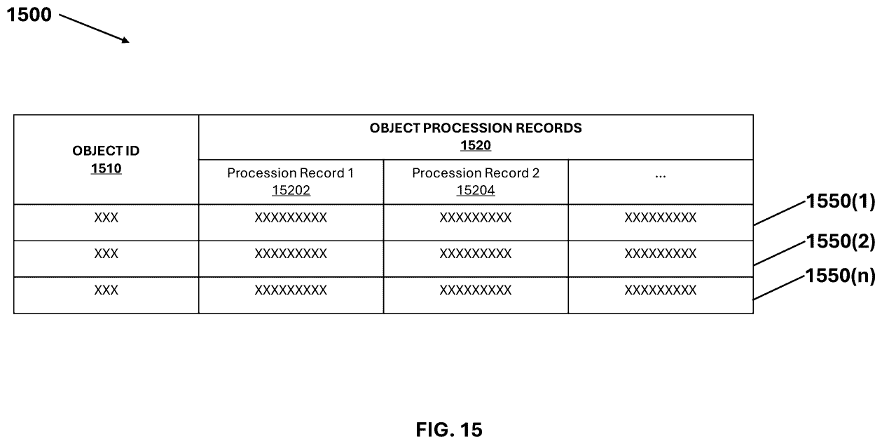

FIG. 15 illustrates an example object stream database 1500. The object stream database 1500 may be stored by an object stream data store. In the illustrated example of FIG. 15, the object stream database 1500 includes a plurality of object streams 1550(1)-1550(n) (generically referred to as object streams 1550). Each of the object streams 1550 may include a plurality of fields. In the illustrated example, each of the object streams 1550 includes an object ID field 1510 and object procession records field 1520. The object ID field 1510 may include a value set that identifies an object (such as a unique number corresponding to an object, a unique string corresponding to an object, a hash of attributes of the object, an embedding vector for the object, etc.). The object procession records field 1520 is indicative of processions made by the object identified in the object ID field 1510 (such as processions through a scene, for example). In some embodiments, the object procession records field 1520 includes multiple sub-fields such as, for example, a first procession record sub-field 15202, a second procession record sub-field 15204, etc. Each procession record sub-field may correspond to a different procession made by the object. Each of the procession record sub-fields may additionally include metadata from, for example, the object-based metadata records 150 described elsewhere herein corresponding to the procession represented by the procession record sub-field and providing additional information about the object.

The object procession records 1520 are non-limiting examples of aggregated identification information for video images in which the corresponding object was detected.

The object procession records 1520 may be at least partially based on location information stored in the plurality of object-based metadata records. For example, procession of an object may be determined by processing the location information stored in the object-based metadata records corresponding to the object to determine how the object moved through the scene. Like movements (e.g., motions made by the object corresponding to a single movement (such as moving towards a location, moving away from a location, staying at a location, etc., for example) may be grouped together into a single procession.

In some embodiments, an object-based metadata record for an object described herein (such as an object-based metadata record 150) includes one or more object streams 1550 corresponding to the object.

Returning to FIG. 13, at block 1306, method 1300 may identify an object of interest. For example, method 1300 may identify, based on the query represented by the user input an object of interest from amongst the objects depicted in the video images of the video feed captured by the camera. The object of interest may be associated with a particular object-based metadata record as described elsewhere herein.

At block 1308, method 1300 may obtain additional information pertaining to the object of interest. The additional information pertaining to the object of interest may, for example, be obtained by the method 1300 from the object stream (such as an object stream 1550 corresponding to the object, for example).

At block 1310, method 1300 may present (e.g., to the user) additional information pertaining to the object of interest. The additional information may, for example, be presented to the user via a GUI.

In the example case illustrated by FIG. 14, the user input included the bounding box 1406 which identified a region of interest of the user. Since the currently displayed video image of the video feed 1404 does not include any objects of interest within the area indicated by the bounding box 1406, the method 1300 may interpret the user input as meaning that the user is interested in finding out more about one or more objects which may have sat on the bench or have moved passed the bench in the past or at some time beyond the current time associated with the video.

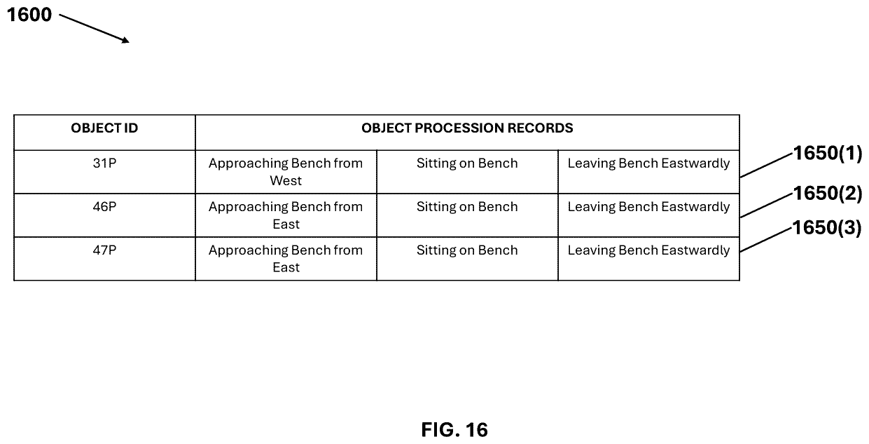

To identify one or more objects which may have sat on the bench or have moved passed the bench in the past, the method 1300 may access example object stream database 1600 illustrated in FIG. 16. Example object stream database 1600 includes object streams 1650 corresponding to objects depicted in video feed 1404. Specifically, object stream database 1600 includes three object streams 1650 (i.e., a first object stream 1650(1), a second object stream 1650(2) and a third object stream 1650(3)) corresponding to objects which have sat or moved past the bench.

The first object stream 1650(1) includes an object ID “31P” identifying the first object stream 1650(1) as corresponding to object “31P” as well as a first procession record sub-field indicating the object's procession towards the bench, a second procession record sub-field indicating the object's procession while sitting on the bench and a third procession record sub-field indicating the object's procession away from the bench.

Likewise, the second object stream 1650(2) includes an object ID “46P” identifying the second object stream 1650(2) as corresponding to object “46P” as well as a first procession record sub-field indicating the object's procession towards the bench, a second procession record sub-field indicating the object's procession while sitting on the bench and a third procession record sub-field indicating the object's procession away from the bench.

Likewise, the third object stream 1650(3) includes an object ID “47P” identifying the second object stream 1650(3) as corresponding to object “47P” as well as a first procession record sub-field indicating the object's procession towards the bench, a second procession record sub-field indicating the object's procession while sitting on the bench and a third procession record sub-field indicating the object's procession away from the bench.

In this example case, the object-based metadata corresponding to object 31P indicates that object 31P is an adult male wearing a blue T-Shirt and that they sat on the bench for 9 minutes starting from 11:03 am on Sep. 17, 2025. The object-based metadata corresponding to object 46P indicates that object 46P is an adult female wearing a black dress and that they sat on the bench for 12 minutes starting from 1:43 pm on Sep. 17, 2025. The object-based metadata corresponding to object 47P indicates that object 47P is a child female wearing a green T-Shirt and that they sat on the bench for 12 minutes starting from 1:43 pm on Sep. 17, 2025. In the example case, objects 46P and 47P correspond to a mother and daughter which came to the bench, sat on the bench and left the bench together.

The three objects identified from the object stream database 1600 as coming into proximity or sitting on the bench may be displayed to the user by the GUI 1400 in an output field 1410. In the illustrated example, the output field 1410 includes three sub-tiles each corresponding to an object which came into proximity or sat on the bench. Sub-tile 1412 corresponds to object “31P”, sub-tile 1414 corresponds to object “46P” and sub-tile 1416 corresponds to object “47P”. The presented information representing the procession of each object through the imaged scene may be obtained from the object stream corresponding to each object. The presented additional information about the object may be obtained from the object-based metadata corresponding to each object. Thumbnails (or other visual representations as described herein) of the three identified objects may optionally be shown as described elsewhere herein.

In some embodiments, each of the three identified objects (i.e., objects 31P, 46P and 47P) may be identified as objects of interest.

In some embodiments, each of the three identified objects (i.e., objects 31P, 46P and 47P) may be identified as potential objects of interest. A user may then select which object from the potential objects of interest is an object of interest. The user may select an object of interest by, for example, interacting with GUI 1400 to select the sub-tile corresponding to the object of interest(s).

If, for example, the user selects sub-tile 1412 corresponding to object 31P (i.e., object 31P is an object of interest to the user), then the user may be presented, via GUI 1400, an expanded version of sub-tile 1412 corresponding to the object 31P and the other sub-tiles (i.e., sub-tiles 1414 and 1416) may be removed. The expanded version of sub-tile 1412 may include further information (or more additional information) corresponding to the object 31P. The expanded version of sub-tile 412 may, for example, include a video clip during which the person was visible, where else the person was seen, etc.

The video tile 1402 is an example of a first region of GUI 1400 through which a user input may be obtained and the output field 1410 is an example of a second region of GUI 1400 through which additional information may be presented to the user.

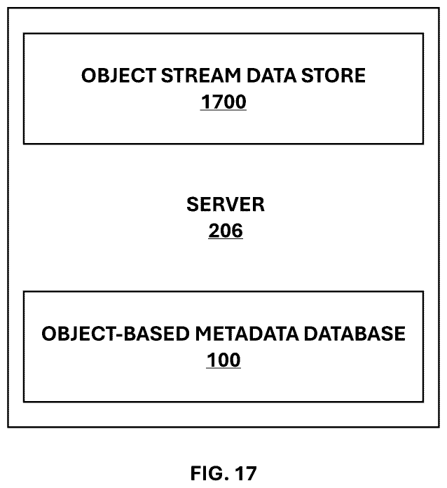

FIG. 17 illustrates an example embodiment of a server 206. In the illustrated embodiment, the server 206 includes an object stream data store 1700. The object stream data store 1700 may store an object stream database or one or more object streams corresponding to one or more objects. Although in the illustrated embodiment of FIG. 17 the server 206 includes object stream data store 1700, server 206 need not include object stream data store 1700. In some embodiments, object stream data store 1700 is a separate component from server 206 or is implemented by a separate component from server 206.

As described elsewhere herein, method 1300 may be performed by at least one server (such as server 206, for example) or another computing entity (or computing entities). The at least one server or computing entity may be part of an investigation system or apparatus (such as a system or apparatus implementing an investigation architecture 200, 200C or 500 described herein, for example). In some embodiments, at least one memory device or data store includes computer executable instructions which when executed by a server or another computing entity cause the server or computing entity to perform the method 1300.

In some embodiments, the method 1300 may be performed using metadata sources storing non-object-based metadata records. For instance, the object stream data store, or another suitable repository of metadata, may store metadata relating to the video footage captured by the camera 202 or 502 in a variety of formats, including frame-based metadata. The identification of the object of interest may be performed from the frame-based metadata, for instance by identifying one of the objects identified as being present in the video image frame from the metadata relating to the frame and which coincides with the user input. By way of another example, if no object of interest is present within a region of interest identified by the user input, the server 206 may search through nearby video image frames to identify an object present within the region of interest at a different time than the query time. Similarly, the additional information relating to the query can be obtained from a variety of sources, including from the frame-based metadata of the video image frame, from frame-based metadata of nearby video image frames, and from other data sources, including a personnel database, an access control event database, an object reidentification database, or the like. In this fashion, even when the object stream data store does not contain object-based metadata, the method 1300 may be performed using other types of metadata whilst still facilitating the obtention of additional information pertaining to an identified object of interest for presentation via the graphical user interface.

In some embodiments, the method 1300 may be performed when metadata is not already present for a given object of interest. For example, a user may interact with the video tile to identify, as an object of interest, an object for which no metadata exists (e.g., a backpack, a laptop computer, a parcel, or the like), whether because the camera 202 (or 502) did not generate metadata for that object, for that type of object, or for any other suitable reason. In such situations, the method may invoke one or more metadata generation applications, which may perform image segmentation, object recognition, pattern recognition, edge detection, or other suitable image analytics, to identify the object of interest. The method may then access the object stream data store to find additional information relating to the object of interest, or may instead apply image analytics, whether of the same type or of another type, on other video footage obtained by the camera 202 (or 502) to determine additional information relating to the object of interest, including persons or vehicles which may have been nearby at various times, information about the entry and/or exit of the object of interest from the scene, or the like.

### CONCLUSION

The present disclosure describes a method of implementing a conversion algorithm such that a plurality of temporal (frame-based) metadata datasets corresponding to a common object ID are converted or aggregated into a single object-based metadata record, and then the object-based metadata record is saved in an object-based metadata database for further investigation. This object-based metadata record includes attributes of the object having the object ID, as well as aggregated timestamp information indicative of when the object appears in the scene. As such, a future investigation that specifies a combination of attributes that matches those of an object for which there exists an object-based metadata record will instantly point to the video image frames where that object is present, helping to improve efficiency of the investigation process.

It should be appreciated that although multiple entities are shown in the cloud 204 as storing various respective databases and exchanging messages, this is only illustrative and is not intended to be limiting. These entities may have any other suitable configurations to respectively communicate with the camera 502 and the user device 208. In other examples, two or more of these entities may be integrated and/or co-located.

Although the present disclosure describes methods and processes with steps in a certain order, one or more steps of the methods and processes may be omitted or altered as appropriate. One or more steps may take place in an order other than that in which they are described, as appropriate.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, certain technical solutions of the present disclosure may be embodied in the form of a software product. A suitable software product may be stored in a pre-recorded storage device or other similar non-volatile or non-transitory computer readable medium, for example. The software product includes instructions tangibly stored thereon that enable a processing device (e.g., a microprocessor) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although various embodiments of the disclosure have been described and illustrated, it will be apparent to those skilled in the art in light of the present description that numerous modifications and variations can be made. The scope of the invention is defined more particularly in the appended claims.

This disclosure further includes, but is not limited to, the following clauses, each of which may be combined with one or more other clauses or any other subject matter in this specification.

1. A method of operating a computing apparatus, comprising:
obtaining, via a graphical user interface, user input indicative of a query relating to a video image of a scene captured by a camera;
accessing an object stream data store comprising a plurality of object-based metadata records, each object-based metadata record of the plurality of object-based metadata records associated with a corresponding object depicted in video images captured by the camera and comprising at least one object stream comprising (i) an object identifier (ID) and (ii) one or more object attributes associated with the corresponding object, the object stream data store comprising aggregated identification information for video images in which the corresponding object was detected;
identifying, based on the query, an object of interest from amongst objects depicted in the video images captured by the camera, the object of interest associated with a particular object-based metadata record;
obtaining, from the object stream, additional information pertaining to the object of interest; and
presenting, via the graphical user interface, at least the additional information.

2. The method of clause 1, wherein the user input is indicative of a selection of one of a plurality of objects depicted in the video image, and wherein identifying the object of interest comprises assigning the object of interest as a selected object from amongst the plurality of objects.

3. The method of clause 2, wherein the user input being indicative of the selection of the one of the plurality of objects depicted in the video image comprises the user input being an interaction with a list displayed within the graphical user interface.

4. The method of clause 1, wherein the user input is indicative of a region of interest in the video image.

5. The method of clause 4, wherein the user input is indicative of an object located within the region of interest, wherein identifying the object of interest based on the query comprises assigning the object of interest as the object located within the region of interest.

6. The method of clause 4, comprising determining that the region of interest indicated by the user input is devoid of any object, wherein identifying the object of interest based on the query comprises identifying an object present within the region of interest at a different time than a time associated with the query and assigning the object of interest as the object present within the region of interest at the different time.

7. The method of clause 6, wherein identifying the object present within the region of interest at the different time comprises searching the object stream data store for at least one of a previous time prior to the time associated with the query for an exit of the object and a future time subsequent to the time associated with the query for an entry of the object.

8. The method of clause 7, wherein searching the object stream data store comprises searching within a predetermined threshold duration from the time associated with the query.

9. The method of clause 6, wherein identifying the object present within the region of interest at the different time than the time associated with the query comprises searching through the object stream data store to identify the object based on location information stored in the plurality of object-based metadata records.

10. The method of clause 9, wherein searching through the object stream data store to identify the object based on location information stored in the plurality of object-based metadata records comprises:
identifying an image space coordinate within the video image associated with the user input;
translating the image space coordinate to location coordinates representative of a location of interest within the scene captured by the camera; and
searching through the object stream data store to identify the object based on the location information stored in the plurality of object-based metadata records being indicative of the object having been present at the location of interest.

11. The method of clause 1, wherein obtaining the additional information pertaining to the object of interest comprises obtaining one of an entry time at which the object of interest entered the region of interest and an exit time at which the object left the region of interest.

12. The method of clause 11, comprising presenting, via the graphical user interface, a portion of the video images captured by the camera associated with the one of the entry time and the exit time.

13. The method of clause 1, wherein obtaining the additional information pertaining to the object of interest comprises obtaining one or more of identity information relating to the object of interest, access control information relating to the object of interest, sighting information relating to the object of interest, and proximity information relating to the object of interest.

14. The method of clause 1, comprising presenting the additional information in association with a visual representation of the object of interest.

15. The method of clause 1, wherein the user input indicative of the query is obtained within a first region of the graphical user interface, comprising presenting the additional information in a second region of the graphical user interface.

16. The method of clause 15, comprising displaying, within the first region of the graphical user interface, the video image.

17. The method of clause 1, wherein presenting the additional information comprises modifying at least a part of the graphical user interface to facilitate presentation of the additional information.

18. The method of clause 17, wherein identifying the object of interest comprises determining a type associated with the object of interest, the method comprising modifying the at least the part of the graphical user interface based on the type of the object of interest.

19. The method of clause 17, wherein obtaining the user input comprises determining a type associated with the query, the method comprising modifying the at least the part of the graphical user interface based on the type of the query.

20. A method of operating a computing apparatus, comprising:
obtaining, via a graphical user interface, user input indicative of a query relating to a video image frame of a scene captured by a camera;
accessing an object stream data store comprising a plurality of metadata records, each metadata record of the plurality of metadata records associated with a corresponding object depicted in the video image frame captured by the camera and comprising an object identifier (ID) and one or more object attributes associated with the corresponding object;
identifying, based on the query, an object of interest from amongst objects depicted in the video image frame captured by the camera, the object of interest associated with a particular metadata record;
obtaining, from the object stream, additional information pertaining to the object of interest; and
presenting, via the graphical user interface, at least the additional information.

1. A method of operating a computing apparatus, comprising:
obtaining, via a graphical user interface, user input indicative of a query relating to a video image of a scene captured by a camera;
accessing an object stream data store comprising a plurality of object-based metadata records, each object-based metadata record of the plurality of object-based metadata records associated with a corresponding object depicted in video images captured by the camera and comprising at least one object stream comprising (i) an object identifier (ID) and (ii) one or more object attributes associated with the corresponding object, the object stream data store comprising aggregated identification information for video images in which the corresponding object was detected;
identifying, based on the query, an object of interest from amongst objects depicted in the video images captured by the camera, the object of interest associated with a particular object-based metadata record;
obtaining, from the object stream, additional information pertaining to the object of interest; and
presenting, via the graphical user interface, at least the additional information.

2. The method of claim 1, wherein the user input is indicative of a selection of one of a plurality of objects depicted in the video image, and wherein identifying the object of interest comprises assigning the object of interest as a selected object from amongst the plurality of objects.

3. The method of claim 2, wherein the user input being indicative of the selection of the one of the plurality of objects depicted in the video image comprises the user input being an interaction with a list displayed within the graphical user interface.

4. The method of claim 1, wherein the user input is indicative of a region of interest in the video image.

5. The method of claim 4, wherein the user input is indicative of an object located within the region of interest, wherein identifying the object of interest based on the query comprises assigning the object of interest as the object located within the region of interest.

6. The method of claim 4, comprising determining that the region of interest indicated by the user input is devoid of any object, wherein identifying the object of interest based on the query comprises identifying an object present within the region of interest at a different time than a time associated with the query and assigning the object of interest as the object present within the region of interest at the different time.

7. The method of claim 6, wherein identifying the object present within the region of interest at the different time comprises searching the object stream data store for at least one of a previous time prior to the time associated with the query for an exit of the object and a future time subsequent to the time associated with the query for an entry of the object.

8. The method of claim 7, wherein searching the object stream data store comprises searching within a predetermined threshold duration from the time associated with the query.

9. The method of claim 6, wherein identifying the object present within the region of interest at the different time than the time associated with the query comprises searching through the object stream data store to identify the object based on location information stored in the plurality of object-based metadata records.

10. The method of claim 9, wherein searching through the object stream data store to identify the object based on location information stored in the plurality of object-based metadata records comprises:
identifying an image space coordinate within the video image associated with the user input;
translating the image space coordinate to location coordinates representative of a location of interest within the scene captured by the camera; and
searching through the object stream data store to identify the object based on the location information stored in the plurality of object-based metadata records being indicative of the object having been present at the location of interest.

11. The method of claim 1, wherein obtaining the additional information pertaining to the object of interest comprises obtaining one of an entry time at which the object of interest entered the region of interest and an exit time at which the object left the region of interest.

12. The method of claim 11, comprising presenting, via the graphical user interface, a portion of the video images captured by the camera associated with the one of the entry time and the exit time.

13. The method of claim 1, wherein obtaining the additional information pertaining to the object of interest comprises obtaining one or more of identity information relating to the object of interest, access control information relating to the object of interest, sighting information relating to the object of interest, and proximity information relating to the object of interest.

14. The method of claim 1, comprising presenting the additional information in association with a visual representation of the object of interest.

15. The method of claim 1, wherein the user input indicative of the query is obtained within a first region of the graphical user interface, comprising presenting the additional information in a second region of the graphical user interface.

16. The method of claim 15, comprising displaying, within the first region of the graphical user interface, the video image.

17. The method of claim 1, wherein presenting the additional information comprises modifying at least a part of the graphical user interface to facilitate presentation of the additional information.

18. The method of claim 17, wherein identifying the object of interest comprises determining a type associated with the object of interest, the method comprising modifying the at least the part of the graphical user interface based on the type of the object of interest.

19. The method of claim 17, wherein obtaining the user input comprises determining a type associated with the query, the method comprising modifying the at least the part of the graphical user interface based on the type of the query.

20. A method of operating a computing apparatus, comprising:
obtaining, via a graphical user interface, user input indicative of a query relating to a video image frame of a scene captured by a camera;
accessing an object stream data store comprising a plurality of metadata records, each metadata record of the plurality of metadata records associated with a corresponding object depicted in the video image frame captured by the camera and comprising an object identifier (ID) and one or more object attributes associated with the corresponding object;
identifying, based on the query, an object of interest from amongst objects depicted in the video image frame captured by the camera, the object of interest associated with a particular metadata record;
obtaining, from the object stream, additional information pertaining to the object of interest; and
presenting, via the graphical user interface, at least the additional information.
